(19) United States
(12) Patent Application Publication
(10) Pub. No.: US 2019/0038932 A1
(43) Pub. Date: Feb. 7, 2019

(54) Relative Response Systems and Measuring Methods

(71) Applicants: Michael Z. Eckblad, Auburn, WA (US); Kenneth DeMile, Auburn, WA (US)

(72) Inventors: Michael Z. Eckblad, Auburn, WA (US); Kenneth DeMile, Auburn, WA (US)

(21) Appl. No.: 16/154,602

(22) Filed: Oct. 8, 2018

Related U.S. Application Data
(63) Continuation-in-part of application No. 12/460,750, filed on Jul. 24, 2009.
(60) Provisional application No. 61/135,779, filed on Jul. 24, 2008.

(51) Int. Cl. A63B 24/00; H04W 84/12; G06F 8/40

(52) U.S. Cl. CPC A63B 24/0006; A63B 24/0062; H04W 84/12; A63B 2220/40; A63B 2225/50; A63B 2220/30; G06F 8/40

(57) ABSTRACT

Mesh networks of radio node pods for measuring performance of teams and individual athletes by first stimulating and then by measuring a parameter of motion selected from velocity, vector, acceleration, force, and rebound. The system includes one or more radio node pods, each radio node pod having a microprocessor, supporting circuitry, a machine layer with one or more sensors and actuators, firmware for essential functions, and a soft socket for receiving “codelets” on the fly, each codelet containing a soft mini-script and attendant variables for iteration of a stimulus-response-sequence (SRS) customized to a previous iteration or training goal. Radio node pods may work in clusters and are typically multipotent, each pod performing specialized functions as dictated by a resident codelet but otherwise all pods having the same or similar hardware. Shared resources, either internal or external to the mesh network, are used for data analysis. Thus a single pod may trigger a stimulus to a user, and another pod may record a response, but are interchangeable, and each response may be a stimulus to trigger another SRS. Communications with an external administrative network or cloud host is generally delegated to a bridge pod dedicated as a gateway or portal. Each individual subject or team is assessed for performance metrics by which a stimulus results in a qualitative or parametric response. According to current best practice, radio pod nodes are synchronized in each mesh network and wirelessly report raw data and/or derived data to an administrative module for reporting, display and recordation. Relative performance of individuals or teams can be tracked or trended to detect weaknesses and improve workout, sports, military training performance, and contests can also be scored using these systems.

### CROSS REFERENCE TO RELATED APPLICATIONS

The present application is a Continuation-in-Part of co-pending U.S. patent application Ser. No. 12/460,750, filed 24 Jul. 2009, which claims priority under 35 U.S.C. § 119(e) from U.S. Prov. Pat. Appl. Ser. No. 61/135,779, filed 24 Jul. 2008, said patent documents being incorporated herein in entirety for all purposes by reference and for which benefit of a chain of priority is hereby claimed.

### GOVERNMENT SUPPORT

Not applicable.

### TECHNICAL FIELD

The present invention relates to systems and methods for wirelessly collecting reaction data of a subject individual or a team to stimuli and, more particularly, to using autonomous radio node pod clusters as a mesh network for sensing and processing behavioral responses by first stimulating and then by measuring and reporting a performance metric.

### BACKGROUND

Measuring a biological reaction to a stimulus is currently problem specific, difficult or impossible to reconfigure, and involves wired data transmission and interconnectivity that interferes with movement. These limitations restrict the ability of coaches, scientists and individuals to understand and optimize the performance of individuals or teams in a general way, whether it be a response of a boxer to a light or a punch coming his way, or relative reaction times and velocities of throws and catches on a baseball team, for example. The responses are complex neuromuscular responses and require a sophisticated apparatus and a full appreciation of the physics of motion and the interaction between moving bodies.

There are currently in existence some attempts at general study of biological systems. We start with some general examples of products and special application efforts. First is the homemade approach as typified by these quotes from http://www.physicsforums.com/archive/index.php/t-173340.html: “I was wondering if anyone could help me. I am trying to measure the speed of a karate punch in order to calculate the force of the strike. I have read several papers on the subject but each of these use a high speed video camera and software such a video to analyze the data. Does anyone know of another way to measure the acceleration? I only have a standard camera at 30 frames per second?” Answers: “Measure the total impulse, by striking a heavy bag and seeing how high it swings.” “If you or one of your friends knows a bit about electronics, it should be quite simple to build a chronograph. Use a couple of strips of aluminum foil a set distance apart as your triggers and punch through them. When you break the first one, the timer starts. The second one stops it.”

A commercial type is illustrated by the “HitMaster” (http://impacttrainingsystems.com/HitMaster.html) which uses various signals and then measures the subject's time to strike a target in response. It will also count the number of hits in a period of time. All data is local to the workout station and all communication is by wired connections. Another type is typified by the Nike or Adidas foot pod which wirelessly sends single user data to a watch or handheld device to be observed by the user.

Finally there are custom research approaches such as seen on “Sports Science” television program, or by large companies or in university studies that rely on custom built sensors, computers, interconnectivity, software, and supporting scientists. These studies are designed to collect data for a specific problem and use it for research or entertainment.

The homemade method suffers from the issues of being non-standardized and having a high variability of accuracy. It avoids any complexities such as wireless or general sensor interface. Thus it is useful only to one end user and his perception of value.

The current commercial versions are centered on a particular application such as boxing or running. Mostly they are wire-connected solutions. They tend to be centered on a single subject and workstation and are not scalable to a whole set of stations able to communicate with all the other stations or produce interrelated relative response data among several interrelated subjects. Further, they lack the flexibility to be re-programmed at any time to perform a completely different function and to accommodate any type of sensor and stimulus hardware configurations not previously considered in the initial design. Further, they lack the flexibility to be re-programmed at anytime to perform a completely different function and to accommodate any type of sensor and stimulus hardware configurations not previously considered in the initial design.

The research solution in general, despite its possible depth and accuracy, is not usable or affordable by most people or even companies. It is a point solution, custom developed to meet a specific need for data, not a specific solution that is affordable for the average individual or company.

Simple single-event-single-measuring systems such as “punch in response to a light” or “counting number of punches in response to a light”, fail to provide the flexibility to measure multiple actions of multiple trainees or team members against each other or in support of each other, and the physics of the actions synchronized to a common time reference. Further, existing systems do not allow for re-programming the complete character and relative measuring capabilities of the systems at any time as part of the normal system function. In the art as currently known and practiced, applications are software or hardware hard-coded for performing one characteristic training protocol from start to finish. Because data collection is also hard coded, a specific and limited stimulus and sensor hardware configuration is also dictated, so that a new application can only be achieved by creating new hardware. These kind of systems lack needed flexibility to be customized and multitasked on the fly.

In contrast, in the inventive systems of the present invention, a system having a multipotent hardware device termed a “radio node pod”, can be wirelessly modified with a few clicks of a mouse from a configuration for training individuals each in a unique way to a system for training teams in any one of many sports, or vice versa, and is not limited in the kinds of sports, exercises or training regimens that it can support.

### SUMMARY OF THE INVENTION

This invention is unique in that it combines wireless mesh networking technology and independent programming and reprogramming, using socketable “codelets”, that serve to re-configure functions of autonomous microprocessor-based “radio node pods” on the fly. The radio node pods are organized into mesh networks that have the capacity to setup, initiate and measure a sequence of events involving one to a plurality of individual trainees or teams relative to each other and/or relative to an absolute reference. Any of the radio node pods of a mesh network of the system can command, initiate, and sense stimulus-response sequence events (SRS) at any time, effectively making a system whose characteristic functions can be changed by instantly installing a series of mini-programs termed here “codelets”. In simple embodiments, these codelets can be iterated to provide a repetitive loop of system functions, such as for training an individual to throw a punch in response to a trigger signal, or for training an individual muscle to flex or extend when stimulated by a touch or by a video movie controlled by the system. In more complex embodiments the codelets can be reprogrammed on the fly so that the training regimen progresses in a series of variations according to the past performance of the trainee, or according to training goals. Because of the ability to re-program the radio node pods, the systems provide a high level of flexibility and capacity for customization. Essentially any sensor or stimulus module (also termed here a “response device” and a “stimulus device”, when suitably configured, can be plugged in and operated by a single apparatus that is automatically recognized by the mesh network and immediately begins to function as a part of a system that is greater than the sum of its parts.

The apparatus includes one or more units termed “radio node pods” having instructions capable of operating a set of machine devices selected from sensors and actuators that are organized around a concept of stimulus-response-sequences or “SRS routines”. The SRS routines may be performed iteratively according to a series of codelets, or in parallel using a mesh network having multiple pods, where the codelets to each of the pods may be unique to each pod.

Typically the wireless mesh network also includes a data transfer linkage via a “bridge pod” that is essentially a radio node pod specially configured with a second radio set or hardwired linkage to transmit or convey the data to an external communications gateway and thence to a notebook, personal computer, smart device, server or an internet address. Radio node pods may be used for this purpose, but the capacity to multiplex data and instructions through a common gateway serves to reduce communications loads in other radio node pods of the network. The system is set up to perform a plurality of re-programmable sequences (each organized as an iteration of the basic SRS concept). The data may be relative to an absolute reference and/or relative to each other. A network of sensors and stimulus devices are provided with the pods and are configured or reconfigured according to the SRS training regimens that are loaded into the system and selected from individual or team activities.

A first objective is to develop a single radio node pod architecture, a common hardware unit, that can multitask and perform various functions as part of a mesh network. It would be advantageous to provide a system of wireless radio node pod(s) that can be re-programmed at any time (i.e., “on the fly”) over an external communications link such as to a server with appropriate software program so as to vary the nature and order of the SRS routines presented to a user according to conditions, user goals, performance feedback, or other contextual variables.

It would also be advantageous to provide a solution that is scalable from one to a plurality of radio node pods that can have a plurality of stimulus or sensor devices attached and can communicate to each other independently or with all radio node pods simultaneously according to radio pod identifiers and addresses known to the system.

It would further be advantageous to have the relative reaction time of each of a plurality of biological responses referenced to either an absolute clock and/or relative to other clocks of other node pods so that stimulus and response events and data collection can be synchronized across all the radio node pods of the mesh network.

Advantageously, the radio node pod units may be miniaturized so as to be embeddable when performing actuation and sensor tasks. Radio node pods may be embedded in any way that allows the accelerometric sensor function to provide a signal that is indicative of and tracks the motion and force parameters being measured.

To realize these advantages, we disclose here a system having the flexibility of radio node pods in a mesh network, in which each radio node pod is supplied with two kinds of program memory, a first that includes a core of instructions (optionally as firmware) for performing basic data and command tasks, and a second kind of memory that is equipped to receive short snippets of code (termed here, “codelets”) that are the snippets of instructions that enable the system to be reprogramming on the fly to perform the basic tasks in unique ways adapted to the immediate context and training regimen goals. These codelets are inserted into the core programming so as to modify or “iterate” the execution of a training regimen. The flexibility of the codelets allows the hardware to be used for any sport or exercise routine and by any number of individuals. A single individual can use the system to train with or without a coach in an individual sport or exercise, or a team can use the system in organized group training to improve overall team performance. Teams may also use the system when playing each other, and individuals or teams can score performance in practice sessions or in tournaments such as competition where collection of performance analytics is part of the game. The system can also keep score, for example.

In a first instantiation, the system comprises: a) a wireless mesh network having a plurality of radio node pods; b) the radio node pods having each a processor, a nonvolatile memory for storing basic core program instructions and a volatile memory for storing codelet program instructions and data, a radio address and a radio node pod identifier, a transceiver for sending and receiving radio signals to and from the mesh network, a portable power supply, a clock, a stimulus device for generating a visual, tactile or acoustic stimulus that defines a stimulus event, at least one response device with sensor or sensors for detecting, measuring and clocking a response to a stimulus, thereby defining a response measurement, wherein said sensor or sensors comprise an accelerometer and each response measurement comprises one or more measurements of one or more vectored parameters of motion of a subject;

c) wherein the processor and the one or more memory elements are configured for receiving, storing and executing program instructions, the program instructions comprising:

i) nonvolatile instructions for executing core functions of a radio node pod, the core functions comprising instructions for generating a stimulus by the stimulus device, for detecting and for measuring a response by the response device, for digitizing stimulus and response data, and for sending and receiving data to and from the mesh network;

ii) volatile instructions addressable to one or any combination of radio node pods of the mesh network, wherein the volatile instructions are wirelessly receivable as a first and a next codelet of a series of addressable codelets, the series defining an iteration of a training regimen, each codelet having associated variables, wherein each codelet is executable in order received, and the codelet and associated variables are configured for structuring the stimulus device and the response device of an addressed radio node pod to perform a function in the iteration; and,

d) wherein the series of addressable codelets are configured to define a first iteration, a next iteration and a prior iteration, the wireless network is configured to perform an analysis of each of the response measurements transmitted to the network, and the associated variables, addresses, and order of the codelets in the series of codelets of the next iteration are reprogrammable by the wireless mesh network according to the analysis of the response measurements in a prior iteration until no further stimulus event or next response is detected.

In other embodiments, the system stimulus device is configured to initiate a first iteration by generating a visual, tactile or acoustic stimulus as a start signal. In some instances, the process of starting and stopping may be repetitive, such as in running laps or punching a bag each time a light blinks or a buzzer sounds. In other instances, the start signal may be given once, and each subsequent play is initiated by the prior play. Thus in another embodiment, the system may be operated such that the response in a first iteration of codelet execution is the stimulus for a next iteration.

Codelets may be transmitted to the mesh network as a series, where individual codelets are addressed to individual radio node pods, thus allowing for a wide range of variability. And by tailoring each round of codelets according to prior performance events, by prior trends in performance, or by training objectives, each series of codelets may be entirely unique.

In complex game play or where complex performance objectives are being measured, the addressable codelets in any series of codelets may be transmitted to a plurality of radio node pods such that any individual radio node pod of a plurality will receive a unique codelet, series of codelets, or codelet variable, thereby enabling radio node pods that are indistinguishable in hardware and firmware to exhibit unique behavior according to the codelet being executed at a given instant as modified for example by a response measurement outcome of a prior iteration or by the role of a player in a game, such as for example a series of codelets sent to a shortstop when a batter makes a hit and a first baseman when the shortstop throws the batter out at first. And similarly, the series of codelets sent to a first boxer during practice when a second boxer scores a body blow and the response the first boxer must make is to block an uppercut to the chin before reclaiming to the offensive. The codelets allow a single set of hardware to be wirelessly adapted from one sport to another.

Thus the system in a preferred embodiment, the mesh network may generate programmable instructions for reprogramming a series of codelets transmitted to each radio node pod so as to adapt a training regimen from a first exercise routine or sport to a second exercise routine or sport. Similarly, the mesh network may generate programmable instructions for reprogramming a series of codelets transmitted to a radio node pod so as to adapt a training regimen according to a performance weakness detected in an analysis of the response parameters detected in a prior iteration.

In another embodiment, the system may include a radio bridge pod. The radio bridge pod typically is provided with a wireless transceiver capable of exchanging data with a wide area network (WAN), whereas other radio node pods of a mesh network may have radio sets suitable only for making and receiving local area network (LAN) transmissions. The bridge pod will be enabled to collect response data from the radio node pods of a mesh network, to transmit the data to a server, for example, on a wide area network, to receive a fresh series of codelets with specified variables from the server, and to transmit those instruction sets to the appropriate radio node pods of the mesh network. The codelets of each series of codelets define an “iteration”, and by swapping out codelets, the system can reprogram the radio node pods to assume new roles or functions according to data and analysis known to the system or server. The server may be configured, for example, for receiving and analyzing parameters of motion from the local network for one or more responses of an individual, calculating one or more individual performance analytics, storing team performance analytics, and displaying team performance analytics on one or more display devices, but also for supplying modified iterations as needed to continue the training regimen. Each training regimen is a series of iterations, each iteration a series of codelets, including a first iteration, a next iteration, and a prior iteration. The server may be configured for reprogramming the associated variables, addresses, and order of the codelets in a series of codelets of a next iteration according to individual profiles, team profiles, team member profiles, historical trends, aggregated or comparative metrics, or behavioral signatures in the performance analytics. Generally, the performance analytics relate to parameters of motion derived from accelerometry data and from timing behaviors. Thus an impact detected when a ball is caught or when a punch is thrown results in follow-on activity such as tagging a runner or starting a timer on a second punch, and each of these is detected by the accelerometer worn by the player or embedded in a piece of sports equipment. As will be described below, radio node pod devices embedded in a ball, a glove or in a punching bag may all share common hardware, but are used to detect and capture performance by wirelessly adapting the radio node pods each time a new set of codelets is loaded for execution by the processor of the radio node pod device.

### BRIEF DESCRIPTION OF THE DRAWINGS

An understanding of the present invention may be obtained by study and reference to the accompanying drawings, when considered in conjunction with the subsequent, detailed description, in which:

FIG. 1 is a concept view of a system for executing and monitoring individual performance in stimulus-response sequences (“SRS”).

FIG. 2 is a schematic of a system for gathering time-based SRS data from individuals or teams using a plurality of autonomous sensor systems synchronized on a mesh network.

FIG. 3 is an overview of a wireless mesh network with multiple radio node pods, a bridge pod, and a cloud host.

FIG. 4 is a schematic of a radio node pod showing a microprocessor supported by internal functional modules illustrated here the form of firmware layers or blocks. Also shown is a mini-script socket for receiving mini-programs (“codelets”) on the fly and executing them.

FIG. 5A is a view of a mini-script socket 501 operatively linked to a microprocessor in a radio node pod 500. Shown here is a python codelet resident in the socket. The radio node pod is in wireless communication with a mesh network and receives updated codelets from the network as specified by a user preference, an administrative shell, or a coaching subroutine. The details of codelet presentation and parameters may be determined by regimens known to improve performance or by feedback from user response parameters. The radio node pod architecture shown here also depicts ASIC subunits, devices such as sensors and actuators overlaid by a machine language layer and higher level communications layers, including a browser or Ethernet compatible language at a highest level.

FIG. 5B shows a process during operation of the system for cyclical loading of codelets into a “socket” built into the cache memory of each radio pod, such that in each cycle the codelet may be modified to create a new behavior or function in the radio pod. After a codelet has been executed, it may be replaced by a new or modified codelet, but in some instances, a codelet will be repeated for multiple iteration rounds because the coded behavior and function do not change with the rounds of stimulus and response. Codelets are not stored because they can be regenerated by the system if desired. A codelet may be repeated for a particular number of counts, where the number of counts is a variable associated with the codelet, or may be repeated until a measured performance parameter changes, such as a parameter indicative of muscle fatigue or a parameter indicative of smooth performance of play action.

FIG. 6 is a second schematic of a mesh network populated by radio node pods and having a bridge pod that serves as a link to a user interface such as a display, an administrative laptop, other smart device, or web portal. Individual radio pods are associated with individual members of a team, although in some instances the radio pods may also be embedded in or associated with exercise or sports equipment.

FIGS. 7A, 7B, 7C and 7D are a sequence of views illustrating a human interaction with a punching bag.

FIG. 8 depicts a more generalized method for measuring a response of an individual subject to a stimulus.

FIG. 9A is a schematic showing use of codelets for executing a single stimulus-response sequence.

FIG. 9B is a chronology (left to right) of two SRS interactions in which a user is presented with a stimulus, then reacts. The SRS is repeated. RNG represents a random number generator used to push reaction times to unpredictable stimuli.

FIG. 10 accompanies a discussion showing how the apparatus can be re-organized on the fly to present multiple points of interaction with an individual in training while synchronized time and force data is acquired.

FIG. 11 extends the concept of a series of interactions A, B, C mediated by a series of socketed mini-scripts. A subject is presented with a stimulus and reacts, but in this instance, each SRS is unlike any previous one. The autonomous mini-programs (“codelets”) are not stored in memory, but are loaded over the mesh network into a set of pods just in time to be the next mini-script that is executed.

FIG. 12 is a view of a response measuring system for providing performance feedback to an individual subject. An external timer provides a reference time synchronization signal through the mesh network.

FIG. 13 is a view of a workout having multiple repeats with data capture to identify performance weaknesses. In one embodiment, the workout can be modified while in progress so as to focus training on a particular skill or muscle group.

FIG. 14A is a view of a radio node pod sewn into a training mitt as used in boxing practice. The radio pod may include a stimulus device such as an LED or a buzzer and a response device typically a sensor for detecting an impact and the motion parameters of the impact. FIG. 14B shows the corresponding method of use. The sensor in the mitt may be a simple switch that closes when hit, or preferably a more complex sensor for accelerometry and motion quantification, including measuring the speed, timeliness and force of the impact.

FIG. 15 is a conceptual view of a training session using a mitt such as might be held by a coach (not shown). The mitt is fitted with a radio node pod and response sensor in wireless communication with a wireless LAN network and a remote server via a WAN network.

Comparative speed, accuracy or force scores for multiple contestants may be displayed on a leader board.

FIGS. 16A and 16B are accessories used in systems of the invention. Each is a radio node pod embedded as a wearable wireless device and having a microprocessor, radio or beacon, mini-script socket, clock and supporting circuitry. Both are secured to an arm, one to better assess acceleration and trajectory, the other to detect tensing characteristic of an early muscle response. These devices are used in conjunction with mesh networks of the invention.

FIGS. 17A, 17B, 17C, and 17D are views of a punching bag configured with an internal spine having multiple circuit boards and sensors disposed over the length of the spine. Signals are transmitted to a radio node pod mounted at the top of the punching bag suspension. Alternatively, the radio node pod may include a load cell or cells mounted in the buckle at the top of the chain suspension or in the “D” rings (FIG. 17A).

FIG. 18 is an electrical block diagram showing the radio set hardware for signals between a radio node pod and a bridge pod. Also shown is a gateway portal from the bridge pod to a cloud host and a smart device.

FIG. 19 is a conceptual view of a radio node pod package with optional display and dual antennae and its interaction with an individual trainee, termed here a “biological transducer”, having an ankle-mounted radio pod and sensor. The processor includes non-volatile memory for core program code and a memory socket for wirelessly receiving mini-scripts (“codelets”).

FIG. 20 is an example of a system configured to score a match between two contestants, each contestant wearing multiple radio node pods that are clustered as a single mesh network with cloud gateway.

The drawing figures are not necessarily to scale. Direction of motion or coupling of views may be shown by bold arrows or boxed figures without further explanation where the meaning would be obvious to one skilled in the arts. Certain features or components herein may be shown in somewhat schematic form and some details of conventional elements may not be shown in the interest of clarity, explanation, or conciseness. It is to be expressly understood that the drawings are for illustration and description only and are not intended as a definition of the limits of the invention.

It is to be expressly understood that the drawings are for illustration and description only and are not intended as a definition of the limits of the invention. The various elements, features, steps, and combinations thereof that characterize aspects of the invention are pointed out with particularity in the claims annexed to and forming part of this disclosure. The invention does not necessarily reside in any one of these aspects taken alone, but rather in the invention taken as a whole. The elements, features, steps, and advantages of the invention will be more readily understood upon consideration of the following detailed description of the invention, taken in conjunction with the accompanying drawings, in which presently preferred embodiments of the invention are illustrated by way of example.

### Glossary

The present invention includes a “relative response system” with reprogramming capability, and with autonomous or interrelated stimulus and sensor systems for measuring biological response data relative to either an absolute reference and/or relative to another biological response. The systems are configured for collecting, and optionally processing, stimulus-response data of subjects (also termed here “biological systems”).

A “wireless network” is used for providing data transmission between radio node pod(s) and bridge pod(s) (where the network between the radio node pods is characterized as a local mesh network) and also, when needed, a transmission path for software reprogramming of radio node pod(s) and bridge pod(s).

“Codelets” are defined as for operating the hardware and firmware define snippets of software or scripts that are short in length but modify larger blocks of core function for operating the hardware and firmware. Codelets are loaded into processor-executable memory that is volatile, so that unlike software instructions stored in ROM memory, the codelet memory is written over each time a new codelet is loaded.

“Radio node pods” include a wireless transceiver, a microprocessor, a power source, independently programmable and reprogrammable instructions in memory or including firmware, for executing sequences of stimulus-response according to changeable programming—either synchronously or asynchronously and with autonomous or interrelated behavior with other response sensors, other radio node pod(s) or other Bridge pod(s) and for communicating on the wireless network.

“Bridge pod” is a radio pod adapted for linked communication from wireless network to the external communication path as well as perform all functions that a radio node pod performs, and wirelessly connected to the radio node pod. Also sometimes termed a “gateway pod” by virtue of its use in connecting to the Internet.

An “external communication path”, for download and upload of programming and/or data between the bridge pod and a plurality of external communications (e.g., network, computer, human, etc.) electrically connected to the bridge pod for displaying data;

“Stimulus-response sequence” (SRS), relates to software- and firmware-coded instructions for executing a plurality independent and/or interrelated stimulus-response actions for an individual biological system or a group of biological systems in order to measure a plurality of biological response data relative to an absolute reference and/or a reference of one response sensor relative to another. The SRS are generally organized around iterations, in which codelets recruit and modify core program code to execute custom steps of a training regimen or to serve in analyzing and scoring match play.

“Trigger device” (also sometimes termed a “stimulus device” or actuator) includes any selection from optical signal hardware such as an LED, inductive devices such as buzzers, bells or diaphragms, shock devices, skin contact devices such as piezoelectric oscillators and resistive heaters, or proprioceptive devices such as contractile bands or belts. The actuator may be remotely mounted, such as on a coaching mitt or target, or may be mounted on the subject, such as in a wristband, an earpiece, a pair of goggles, a mouthpiece, or in a skin patch. The common denominator is a capacity to emit or apply a stimulus that can be sensed and can elicit a biological response: a dog whistle for example;

“Response device or response sensor”, includes hardware for sensing any aspect of a behavior, particularly a body in motion, and is electrically connected to the radio node pod. Trigger devices include lights, buzzers, bells, vibrators, shocks, and so forth. Response sensors include load cells, accelerometers, pressure switches, motion sensors, GPS monitors, and so forth.

Accelerometry is a preferred response measurement, and relates to direct and derived parameters of motion, including reaction time, impact time (both of which can be detected using an accelerometer), and also velocity, acceleration, and force. Trajectory can be derived by analysis of data from a multi-axis accelerometer such as the 9-axes accelerometers commonly integrated into many modern chips.

The term “module” can refer to any component in this invention and to any or all of the features of the invention without limitation. A module may be a software, firmware or hardware module, and may be located in an apparatus, a device, or a server, for example.

“Computer” means a virtual or physical computing machine that accepts information in digital or similar form and manipulates it for a specific result based on a sequence of instructions. “Computing machine” is used in a broad sense, and may include logic circuitry having a processor, programmable memory or firmware, random access memory, and generally one or more ports to I/O devices such as a graphical user interface, a pointer, a keypad, a sensor, imaging circuitry, a radio or wired communications link, and so forth. One or more processors may be integrated into the display, sensor and communications modules of an apparatus of the invention, and may communicate with other microprocessors or with a network via wireless or wired connections known to those skilled in the art. Processors are generally supported by static (programmable) and dynamic memory, a timing clock or clocks, and digital input and outputs as well as one or more communications protocols. Computers are frequently formed into networks, and networks of computers may be referred to here by the term “computing machine”. In one instance, informal internet networks known in the art as “cloud computing” may be functionally equivalent computing machines, for example.

“Processor” refers to a digital device that accepts information in digital form and manipulates it for a specific result based on a sequence of programmed instructions. Processors are used as parts of digital circuits generally including a clock, random access memory and non-volatile memory (containing programming instructions), and may interface with other digital devices or with analog devices through I/O ports, without limitation.

The term “network” can include both a mobile network and data network without limiting the term's meaning, and includes the use of wireless (e.g. 2G, 3G, 4G, WiFi, WiMAX™, Wireless USB (Universal Serial Bus), Zigbee™, Bluetooth™ and satellite), and/or hard wired connections such as internet, ADSL (Asymmetrical Digital Subscriber Line), DSL (Digital Subscriber Line), cable modem, T1, T3, fiber, dial-up modem, television cable, and may include connections to flash memory data cards and/or USB memory sticks where appropriate. A network could also mean dedicated connections between computing devices and electronic components, such as buses for intra-chip communications.

A “method” as disclosed herein refers to one or more steps or actions for achieving the described end. Unless a specific order of steps or actions is required for proper operation of the embodiment, the order and/or use of specific steps and/or actions may be modified without departing from the scope of the present invention. A software implemented method or process is here, and generally, understood to be a self-consistent sequence of steps leading to a desired result. These steps require physical manipulations of physical quantities. Often, but not necessarily, these quantities take the form of electrical or magnetic signals or values capable of being stored, transferred, combined, compared, and otherwise manipulated. It will be further appreciated that the line between hardware and software is not always sharp, it being understood by those skilled in the art that the software implemented processes described herein may be embodied in hardware, firmware, software, or any combination thereof. Such processes may be controlled by coded instructions such as microcode and/or by stored programming instructions in one or more tangible or non-transient media readable by a computer or processor. The code modules may be stored in any computer storage system or device, such as hard disk drives, optical drives, solid state memories, etc. The methods may alternatively be embodied partly or wholly in specialized computer hardware, such as ASIC or FPGA circuitry.

### DETAILED DESCRIPTION

In a preferred embodiment, a wireless system of independent radio node pods is used for initiating, collecting, and optionally processing, absolute and/or relative response data of biological systems to stimulus and then using a wireless mesh network to transmit the data to a plurality of external communication members (e.g., a human interface device) via a bridge pod. A plurality of sensors and trigger devices are connected to or integrated in the radio node pods according to the purposes of the programmed stimulate response sequences. This system is beneficial for measuring stimulus-response data for any biological activity in a relatively independent response manner, making it quite general, capable of reconfiguration, and customizable.

The system is set up to perform a plurality of sequences of i) stimulus, followed by ii) response measurement through the wireless network. The elements of the sequence can be changed on each radio node pod via re-programming at any time to create new configurations and metrics. The sequences may execute on each radio node pod(s) and bridge pod(s) autonomously or the programming can create a plurality of different interrelated sequences depending on system objectives.

Thus, interrelated reactions of any number of trainees relative to each other can be measured, processed and communicated to any desired device for further processing or display. Individual performance or entire team's relative performance can be tracked to improve performance in a plurality of ways for a plurality of sports, military exercises, and so forth.

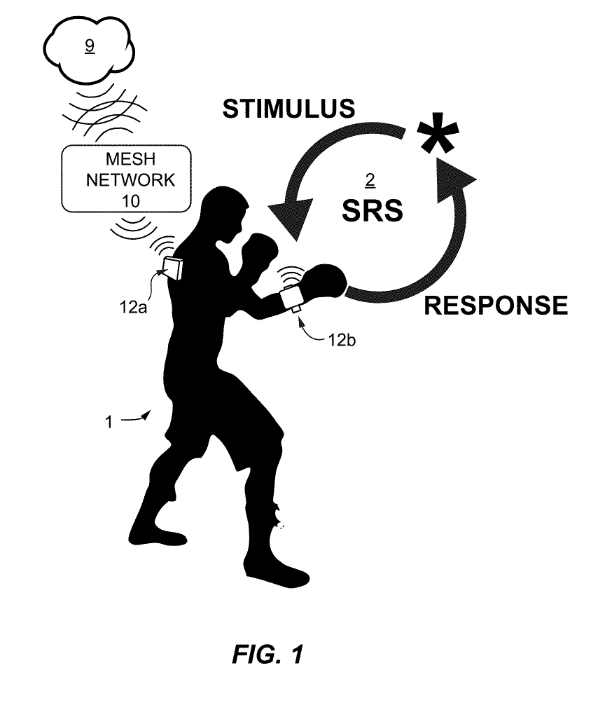

FIG. 1 is a concept view of a system for executing and monitoring performance in stimulus-response sequences (“SRS”), indicated here by a closed loop (2, circular arrows). Sensors worn by a user 1 are operatively coupled to a mesh network 10, and when a stimulus is presented to a user (*), the user receives the stimulus (upper arrow) and reacts (lower arrow), generating a detectable response with motion parameters (including reaction time) that are qualitatively or quantitatively monitored. Data is recorded and analyzed as a means of making comparisons between multiple users or groups and as a means of evaluating relative performance over time, as in a training program. Communications mediated by the mesh network may include a wireless comm link to a cloud server 9.

The system includes one or more radio node pods (12a,12b), each radio node pod having a microprocessor, supporting circuitry, a machine layer with one or more sensors and actuators, firmware for essential functions, and a soft socket for receiving “codelets” on the fly, each codelet containing instructions that taken together are an iteration of a stimulus-response-sequence (SRS). Radio node pods may work in clusters as a mesh network 10 and are typically multipotent, each pod performing specialized functions and using shared resources of the mesh network for data analysis. Thus a single pod may trigger a stimulus to a user, and another pod may record a response.

Communications with an external administrative network or cloud host 9 is generally delegated to a bridge pod dedicated as a gateway or portal. In practice, program ‘codelets’ are wirelessly delivered “just in time” from a higher network to the microprocessors in the node cluster. Each subject 1 converts a stimulus (*) into a qualitative or parametric response. Node clusters are synchronized and wirelessly report raw data and/or derived data to an administrative module. Relative performance of individuals or teams can be tracked to detect weaknesses and improve performance in workouts, sports play, military training, and so forth.

### Detailed Description of Components

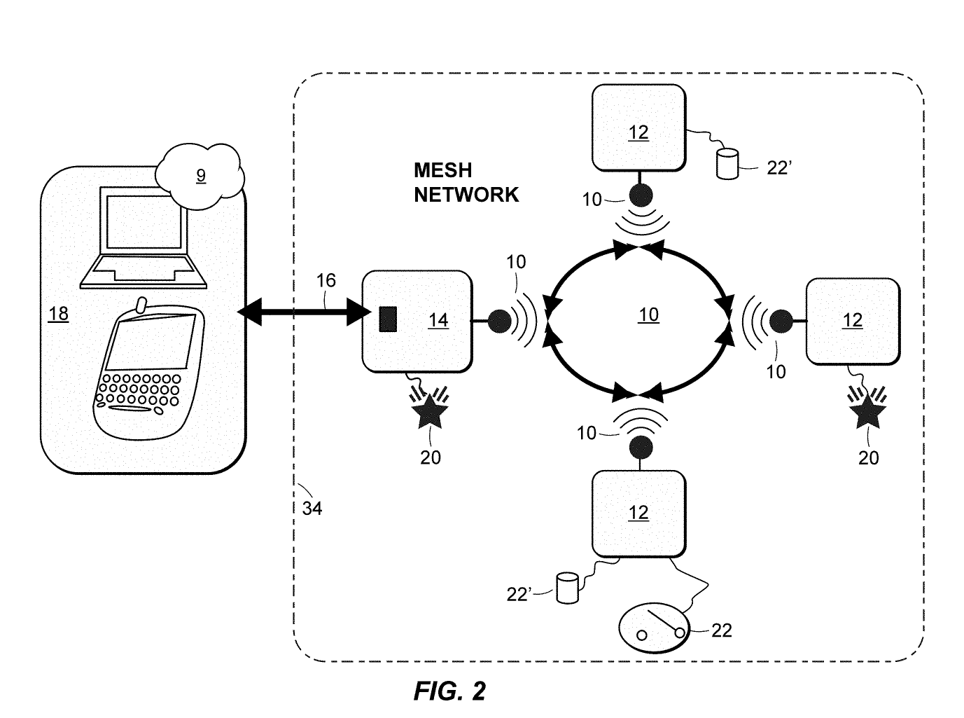

Shown in FIG. 2 are components of a representative system of the invention. The system initiates and collects biological response data either asynchronously or in a synchronized manner according to stimulus-response sequence events 2 established within the various radio node pods 12 in the system. The data is then and displayed in a plurality of ways.

The individual components include: wireless mesh network 10, pod(s) 12, bridge pod 14, external communications network link 16, human interface 18 (including smart phones, laptops, internet server, and so forth), trigger device 20 (here suggested as a light; while not limited thereto), and one or more response sensors (where 22′ is for example an accelerometer and 22 is a switch having an open and closed state or position).

The system may include a wireless network 10 of any standard topologies capable of transmitting data in or out of radio node pods 12 and bridge pod 14. A preferred wireless network is a mesh network. The radio node pod 12 may gather data a sensor or a plurality of sensor devices. Sensors include switches, accelerometers, GPS, altitude data, heart rate monitor, blood pressure monitor, body temperature sensor, and so forth.

The radio node pod 12 has at a minimum a microprocessor, wireless communication hardware and any of a plurality of machine elements, typically as firmware driven devices, depending on the desired behavior for the radio node pod 12. Radio node pods may have limited resources for data storage.

Radio node pods may be provided with a “response module” having multiple sensor devices and a “stimulus module” having multiple trigger devices. Internal circuit architectures will be described in more detail below.

In addition to firmware components, radio node pods typically contain a mini-script “socket” in operative digital linkage with the microprocessor. The mini-script socket wirelessly receives software “codelets” from the mesh network. The codelet is dropped into the socket so that the instructions for performing an SRS routine are executable by the processor. Firmware in each radio node pod is configured to perform the machine steps but the codelet will establish the nature of the steps, parameters to be used in scaling each step, and in many instances the coordination of a cluster of pods that are “recruited” from available system resources to perform the routine. Codelets may be executed by radio node pod clusters in series, in parallel, iteratively, or manually from a drag-and-drop coaching interface. Codelets may also be downloaded from a cloud host on user commands.

Thus the memory may be divided into two or more functional categories that correspond generally to ROM and RAM chip functions. There is nonvolatile memory unit for storing basic core program instructions, a volatile memory unit defining a socket for storing codelet program instructions, and a volatile memory unit for storing variables and data and serving as a buffer when loading or receiving data from the processor. This is sometimes also the function of cache memory.

Timing synchronization may be handled by a reset to the mesh network from a system clock or by a reference clock in each radio node pod. Once the codelet is activated, the radio node pod, working in cooperation with other radio node pods executing the same instruction set, executes a series of machine steps ranging from actuating a trigger stimulus to measuring a response or analyzing data. Optionally, the radio node pod 12(s) can condition signals from sensor devices and then provide the data to the any of the bridge pod 14(s) or to any of the other radio node pod 12(s). Any of the pods may be used to initiate a plurality of synchronous or asynchronous data collection sequences with all or a subset of the other radio node pods or bridge pod 14.

The external communication path 16 provides a means for the bridge pod 14 to communicate outside the wireless network 10 to an external communications host or portal 18. A plurality of methods and standards can be used for conveying messages, including radio LAN and/or WAN wired connections, Bluetooth, or via a cloud bus network such as the Internet. Generally communication is bidirectional, permitting direct load of codelets into radio node pods when transitioning from one SRS to a next SRS.

For example, the external communications 18 may be co-located with the bridge pod 14 having an Ethernet cable to a local network and an integrated display or human input device. But in another example, the bridge pod 14 is positioned on the east coast and a smart phone (external communications member 18) on the west coast uses the Internet to connect to the bridge pod 14 via a server to program the radio node pod 12(s) or bridge pod 14 to have a particular behavior and then uses the same connection to initiate and collect the data for a stimulus-response sequence 2. External comm 18 is defined as outside a wireless network boundary 34 of a mesh network. There can be anywhere from zero to a plurality of bridge pod 14(s) in a system. For example, a system may operate without a bridge pod when it operates independently of external communications 18.

In a preferred embodiment, the external communications gateway or portal 18 is selected from a plurality of devices including PC computer, Internet devices, laptop, PDA (Personal Data Assistant), Smart Phone, etc. with an interface for input or review of information from the system. Also envisaged are inputs and outputs such as a separate keyboard and separate LED or LCD display that simply connect directly to the bridge pod 14.

The trigger device 20 is used to cause the biological system 24 to respond either voluntarily or involuntarily. The trigger device 20 could stimulate any of the senses or directly actuate a nerve. An example of a stimulate device 20 is a light that illuminates to cause a human to throw a punch.

The trigger device 20 may be distinct from an initiator switch. Any of the pods may be used to initiate an SRS cycle with all or a subset of the other local pods 12 and a bridge pod 14. The local pod 12 and bridge pod 14 drive or read data to and from an attached trigger module 20 or sensor module 22 respectively. Data may be obtained when the module is plugged into the pod, but alternatively the pods may be specialized for triggering and/or sensing, and an SRS cycle from memory is initiated by an external command, such as from an administrative user or by pressing a button on any one of the pods.

In contrast, the trigger device may be actuated multiple times in an SRS cycle. Triggers are inputs that the subject can recognize and respond to. Triggers include optical signals, audible signals, skin sensations of vibration or warmth, shocks, jets of air, feelings in the mouth, hand or in the ear of a subject, and so forth, and are administrated for example by wearing a pod as a mouthpiece, a skinpatch, a hearing insert, a hand grip, a wrist band, or helmet, or by mounting a trigger device on a target or on an apparatus such as a punching bag, elliptical, bicycle or a training mitt. Commonly used triggers are one or a plurality of actuation devices such as lights, buzzers, bells, vibrators, blowers, and so forth.

We note that a response is frequently also a stimulus, as when a first player hits a tennis ball over a net, so that the stimulus for the second player is to intercept the moving tennis ball and the response for the second player is to hit it back, thus creating a self-sustaining cycle of stimulus and response that ends when one of the players misses a shot.

The response sensor (22,22′) translates biological responses into signal useable by the radio node pod 12. The signals are then used by the radio node pod 12(s) to sense the state of the biological response, for instance, a switch (response sensor 22) that closes (changes state) when struck by an impact. Another example would be an accelerometer (response sensor 22′) worn a human track runner that records acceleration over a period of time (time history). Using double-integral techniques triaxis accelerometers may also be used to plot a trajectory of a body part when performing an exercise, and using transfer functions, to derive relative force delivered by a user on a target. A bridge pod, or a specialized radio node pod, may also include a display or annunciators to communicate with a human and may include a plurality of input or output human interface devices.

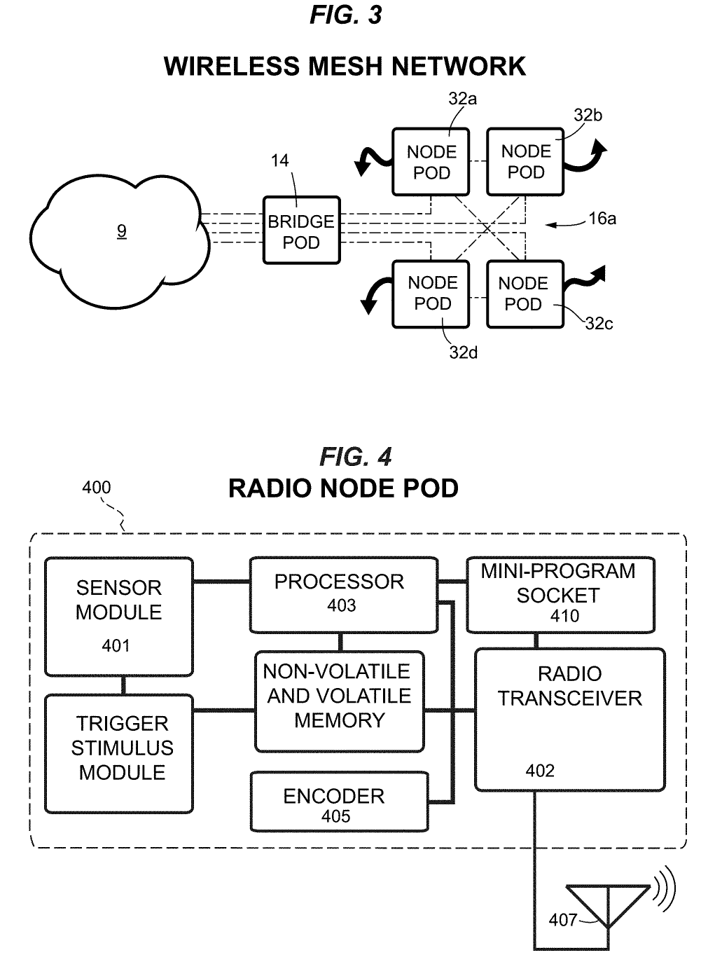

FIG. 3 is an overview of a wireless mesh network with multiple radio node pods (32a,32b,32c,32d), a bridge pod 14, and a cloud host 9. Communication is generally peer-to-peer, occurring between all members of the mesh network, but a specialized bridge pod 14 and comm link 16a is advantageous in centralizing broadband traffic with a higher level network. Bridge pods may be specialized by incorporating added buffer memory, plugs for hard wired connections to an Ethernet port, a UART, or a display for example, power sources other than battery, and higher powered radio sets.

FIG. 4 is a schematic of a multipotent radio node pod 400 showing a microprocessor 403 supported by typical internal firmware and a mini-script socket 410 for receiving mini-programs on the fly and executing them. Also shown is on-board memory, a radio transceiver 402 with antenna 407 and encoder 405 for formatting transmissions. Sensor module 401 may include one or more sensors and supporting logic to condition or analyze signals and an A/D converter to digitize signals. Alternatively, signal analysis may be performed using other mesh network resources or in an external computing machine having greater analytical, display, scoring and archiving capability.

Various examples of hardware that may be used to implement the concepts outlined herein include, but are not limited to, application specific integrated circuits (ASICs), field-programmable gate arrays (FPGAs), and general-purpose microprocessors coupled with memory that stores executable instructions for controlling the general-purpose microprocessors. In a preferred embodiment, on-board devices are controlled by firmware or microcode, and software is received in mini-script sockets 410 and executed without the need to be compiled, as will be described next.

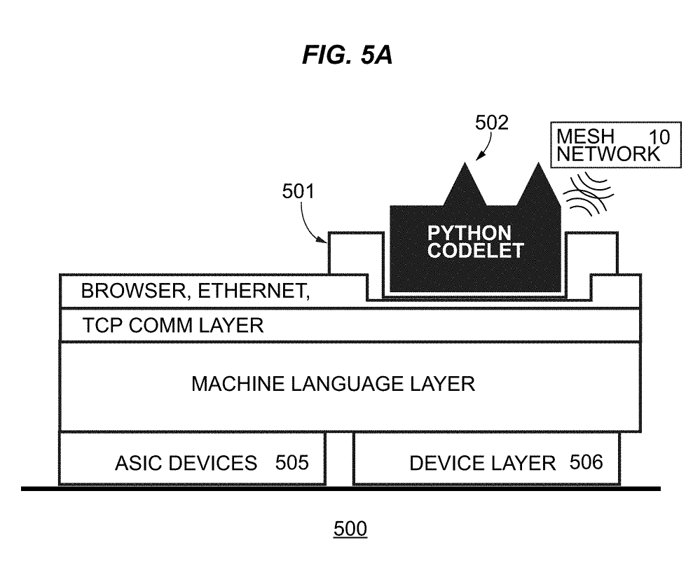

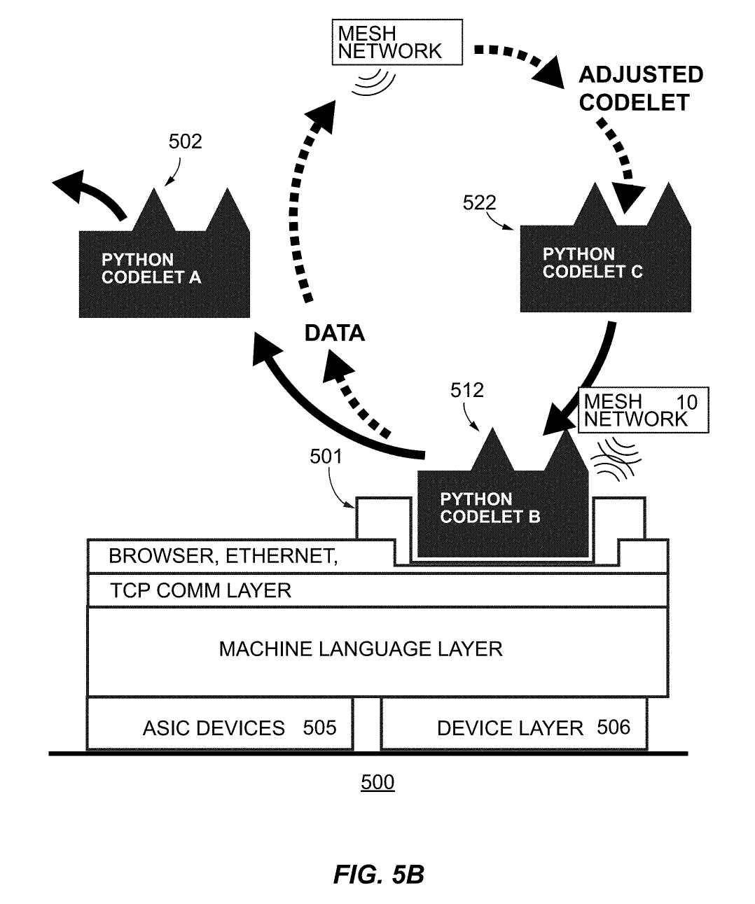

FIG. 5A is a view of a mini-script socket 501 operatively linked to a microprocessor 500 (shown here as an integration of multiple hardware layers) in a radio node pod. A codelet 502 is resident in the socket 501, in this case the mini-script codelet is written in Python, which does not require a compiler. Other scripting languages, including the PyDatalog add-on, Julia, Go, Coffeescript, Dart, Ocaml, Perl, for example, are options, but importantly, scripting like Python can construct and execute program fragments on the fly, thus the term “codelets”.

The radio node pod is in wireless communication with a mesh network 10 and receives updated codelets from the network in real time as the workout or exercise program progresses. The particulars of the codelet order are driven by a user preference, an administrative shell, a coaching subroutine, some sensor feedback, or context more generally. The details of codelet parameters may be determined as part of a feedback loop based on user response parameters, such as resistance, frequency, duration, intervals, and so forth, that can be assessed by monitoring heart rate, or a particular program may be tailored to meet a calorie burn goal, for example, or to improve reaction speed.

The radio node pod processor architecture shown here depicts a lowest level populated by ASIC device subunits 505 and devices 506 such as sensors and actuators. This is overlaid by a machine language layer and higher level communications layers, including a browser or Ethernet compatible language at a highest level.

FIG. 5B shows the cyclical loading of codelets 502, 512, 522, into a socket, such that in each cycle the codelet may be modified to create a new behavior or function in the radio pod. After a codelet has been executed, it may be replaced by a new or modified codelet, but in some instances, a codelet will be repeated for multiple rounds because the coded behavior and function do not change with the rounds of stimulus and response. Codelets are not stored because they can be regenerated by the system if desired. Codelet A may be described as driving a “prior iteration”; codelet B as driving the current iteration, codelet C as the “next iteration”. However, where multiple radio node pods are operative, each pod may receive a separate series of codelets that define the iteration.

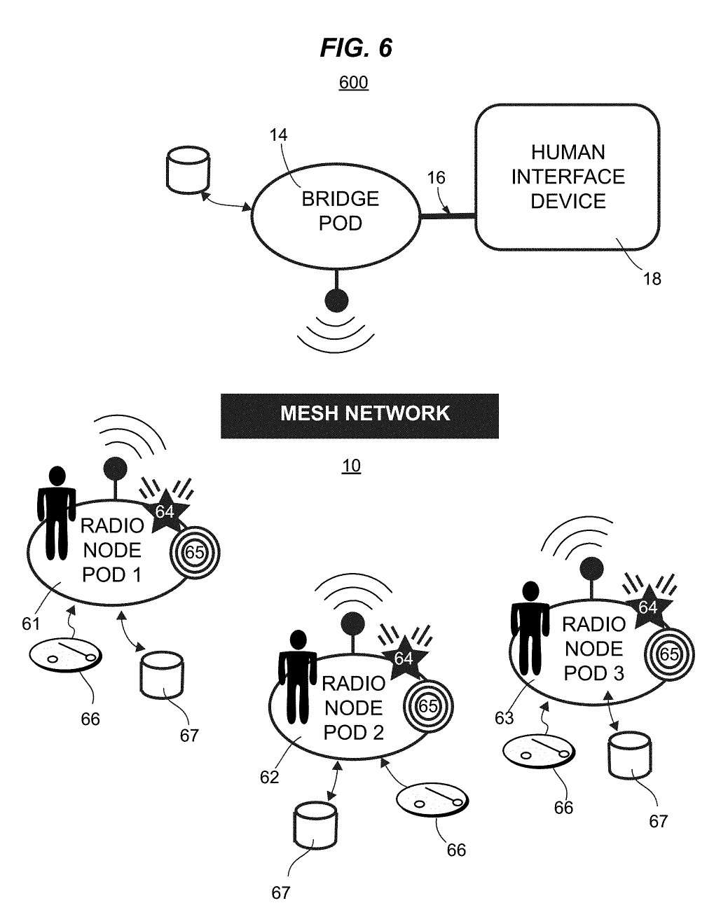

FIG. 6 shows another configuration wireless radio node pods populating a mesh network 10, also including at least one bridge pod 14 with a “comm link” 16 to a computing device with user interface 18 such as a display, an administrative laptop, or other smart device. The system 600 is an integrated system of components that initiate and collect biological response data either asynchronously or in a synchronized manner according to programmed sequences established within the various microprocessors in the system. The data is then processed and displayed in a plurality of ways.

In this example, each radio node pod (61,62,63) can have a trigger device (light, 64, buzzer 65), an impact sensor 66 and an accelerometer 67) for capturing data. The radio node pods are identical and may be embedded in a glove or worn on a wrist. The three radio node pods are used by team members and serve to capture and transmit data to the bridge pod 14.

Even more surprisingly however, the roles the radio node pods play are dictated not as much by the device structure (sensors and actuators) but on a dynamic software snippet (‘codelet’) loaded into a socket and run by the microprocessor in each iteration. At any given time, the codelet may be the same in each radio node pod or may be different, but the combination of all the software and hardware forming the system will behave as a single integrated machine in presenting an SRS routine to a user, detecting and collecting data, and transmitting formatted data through the mesh network for analysis of one or more parameter of motion. Thus each radio node pod can have identical hardware, but can be used by team members playing different positions and by team members alternating in roles between stimulating a response (e.g., throwing a ball) and executing a response (e.g. catching a ball).

In one instance, here a team warm-up activity, at a trigger signal given by sound actuator 20′, a first player with a baseball glove containing radio node pod 61 may throw a ball to a second player (radio node pod 62) and the system sensors 66,67 may capture the timing of the throw and the velocity (because an accelerometer associated with pod 61 times the release of the ball thrown by the first player and an accelerometer or impact switch associated with pod 62 times the impact of the ball in the second player's glove). The second player wearing radio node pod 62 responds by catching the ball and this in turn starts a clock (i.e., catching the ball is a stimulus event) to measure the second player's reaction speed in throwing the ball to the third player (radio node pod 63). In each case, the data capture and management is executed by a codelet. One codelet is used for sensing when the ball is thrown, another for sensing when the ball is caught, and all the devices are operated with synchronized clocks. Because each radio node pod has a stimulus device and a reaction device with sensor capability, reconfiguring the microprocessors is readily accomplished by transmitting and loading another series of codelets, delivered wirelessly from the bridge pod at megahertz speed. With this system, adding another iteration so that the sequence includes another a fourth step in which player 3 throws the ball back to player 1, requires no new hardware and can be done wirelessly with no new programming except the swapping out of the needed codelets.

Many combinations are possible because each radio node pod may have a cluster of trigger devices and sensors. These integrated systems provide a plurality of configurations. Part of the reason for this is that the radio node pods generally have multi-device capacities, and are re-programmable at any time. This behavior may be completely independent and dependent relative to any other pod 61,62,63, while synchronized by a system clock or a relative clock.

The system is not tied to any particular sport or activity or even a specific biological system. The same hardware can be used by hockey players practicing forwarding a puck as they skate down the ice except that the radio node pod might be embedded in a hockey stick rather than a baseball glove. The same hardware can be used in a badminton game, where each player has a radio node pod embedded in a racquet. Optionally another of the radio node pods may be embedded in the shuttlecock so that the trajectory of the shuttlecock can be evaluated.

### How the System Works

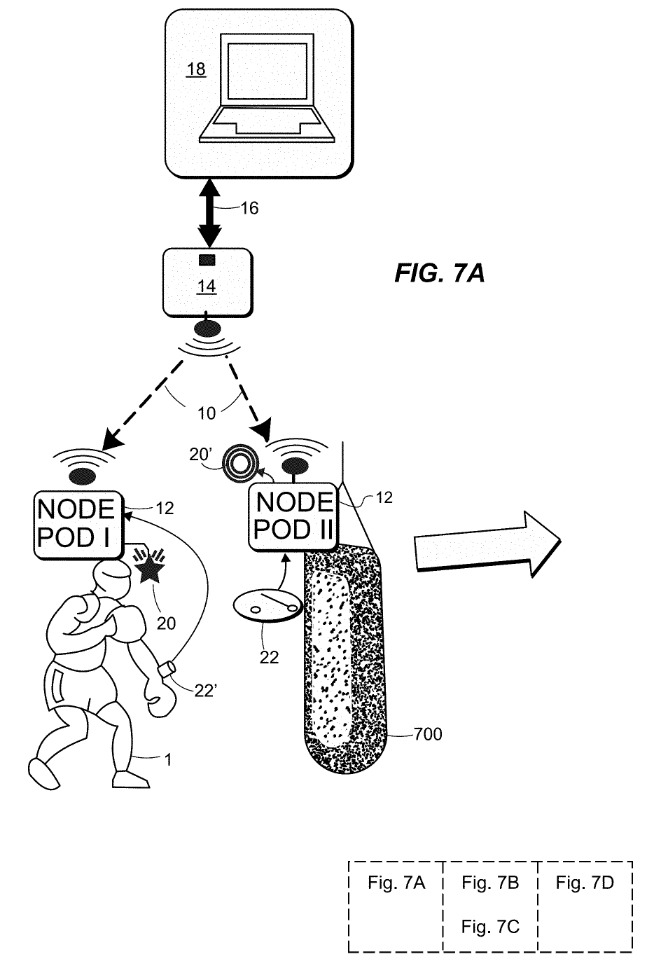

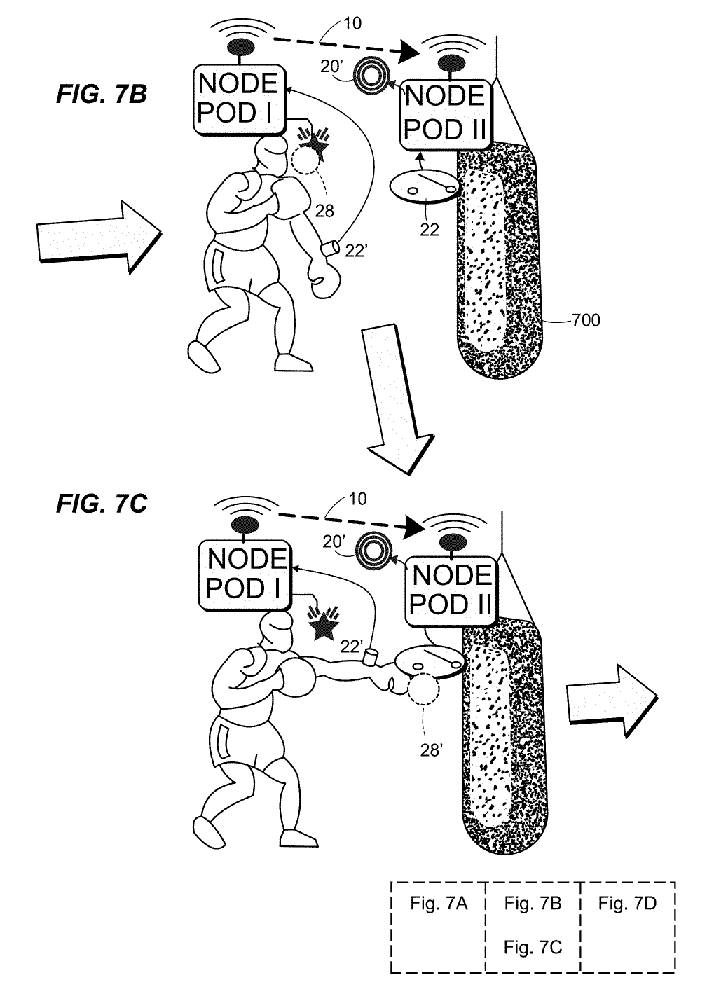

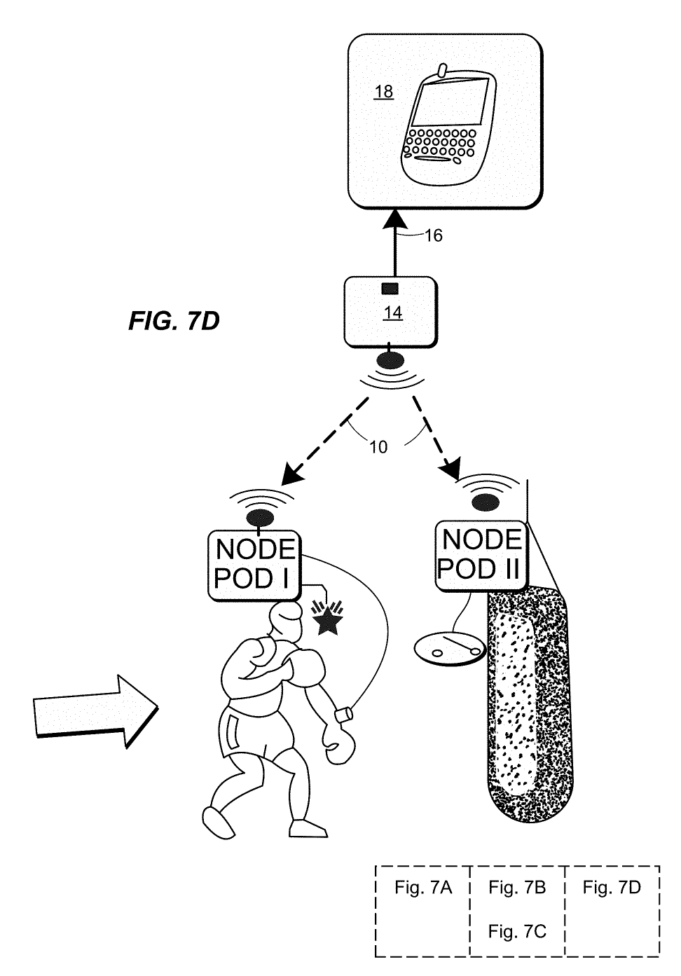

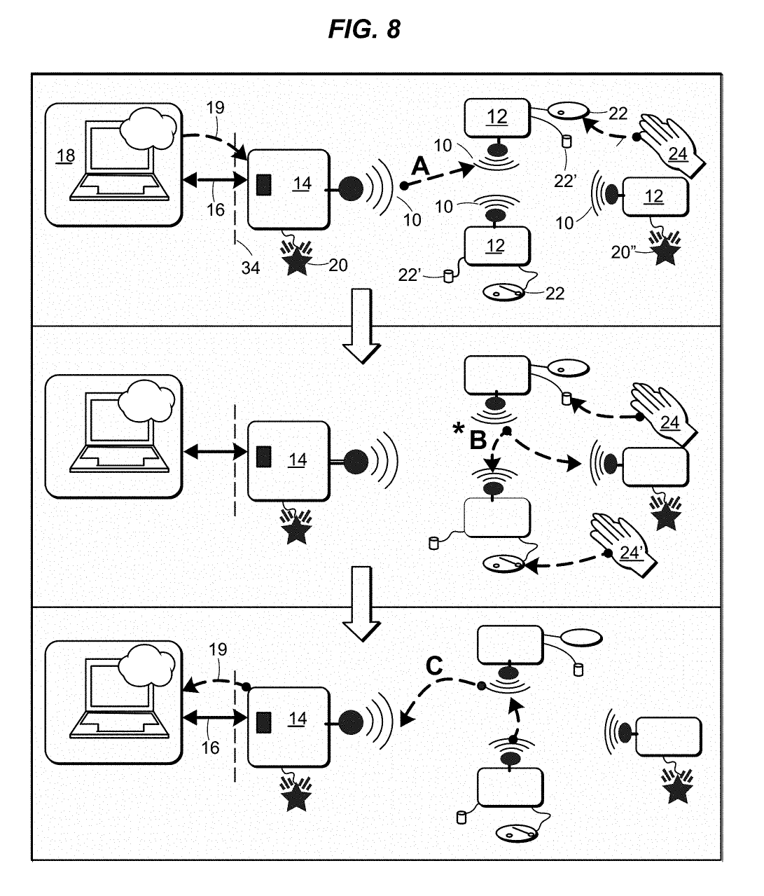

FIGS. 7A, 7B, 7C and 7D are a sequence of views illustrating a method for measuring relative reaction parameters of a user interacting with a punching bag. Synchronized time and force data are acquired by sensors, one sensor worn by the athlete, the other sensor embedded in a punching bag. Views of the basic functions of the system are presented as a series of steps of a method.

In this method, only two radio node pods 12 (labelled, node pod 1 and node pod 2) are needed in combination with a bridge pod 14 and a higher network function, here represented by a laptop 18 linked to the bridge pod by external comm link 16.

Views of the basic functions of the relative reaction sensor and analysis system are presented in a series of steps of a method.

A sequence of views illustrates an application of a relative reaction sensor in a subject 1 interaction with a punching bag 700. The system and method is set up to measure strike force and is synchronized to measure reaction time. Radio node pod 1 is configured with a trigger device 20 and response sensor 22′. Punching bag 700 includes radio node pod 2, which is configured with a trigger device 20′ and a response sensor, here depicted as switch sensor 22. In this example, a first radio node pod is attached to the wrist of subject 1 and a second radio node pod to punching bag 700.

The system may be installed and set up by a human on a notebook (external communications link 16 to computing machine 18) to have radio node pod I to turn on light (20) and send a codelet for radio node pod II to configure itself to sense a subsequent impact. To start (FIG. 7A), an SRS routine is sent as a script from the laptop 18 to the bridge pod 14 and then specific codelets are sent individually to radio node pod I and radio node pod II. At time zero, trigger device (20) is turned on (FIG. 7B, 28), and radio node pod I communicates via the wireless network a start timing command to all involved radio node pod(s). The subject then hits the punching bag 700 as soon as possible to stop the timer (FIG. 7C, 28′). The synchronized SRS data may be transferred to the bridge pod from both radio node pods so as to measure the time delay between the actuation of trigger device 20 and an impact detected by switch 22. This result is a response time and indicates the delay between the trigger actuation and the user hitting the bag.

The subject then adjusts body stance to deliver another punch, as shown in FIG. 7D. By modifying the codelet in note pod I, the time it takes for the subject to regain a fighting stance can also be tracked. The system will analyze the data and determine the time taken to be ready for delivering a second punch.

During the first punch iteration, an accelerometric sensor 22′ tracks location and motion of the athlete's hand. The accelerometer is part of radio node pod I and is attached to the subject's wrist. Accelerometry and switch data is fed into mesh network 10. By equipping the radio node pods with multi-access accelerometers and a capacity to calculate trajectories, relative location data may also be calculated (in the radio node pod, the bridge pod, or on the laptop) until the first hits switch 22 (28′, FIG. 7C). Impact time and data is recorded by radio node pod II. Part of the data is on radio node pod I and part of the on radio node pod II, but all the data is synchronized relative to a common to time. When the switch is closed, indicating an impact, the impact event is transmitted to radio node pod I so as to stop response data collection. In this example, after the SRS cycle is complete, radio node pod I and radio node pod II send their data to bridge pod 14 to be post-processed and then displayed on the external communications portal 18 as a plot of acceleration versus time or location on an X,Y,Z plot. This plot shows the relative efficiency of the boxer and the condition of the muscles involved in making a punch. A new iteration sequence of events may then be sent over the external communications 18 and installed on radio node pod I, causing light 20 to flash quickly and demanding more speed from the subject. A buzzer 20′ on radio node pod II sounds if the speed is not faster than before, thus providing a feedback system to the boxer.

Alternatively, a new SRS routine is loaded onto the radio node pod II, causing it to read time and number of punches per second. As the boxer completes this iteration sequence, the data from radio node pod II (due to the new programming) is stored in the onboard memory cache and then at a specified time, uploaded via bridge pod 14 and external communications link 16 over the internet portal 18 with a specified internet address and the subject's best time is compared to a qualifying time needed for entry into a tourney.

In more complex variations, a second boxer (not shown) and punching bag with equivalent radio node pod(s) may be set up six feet away. The second boxer sequence receives a stimulus trigger when the first boxer hits his punching bag. Switch response sensor 22 starts a timing loop for the second boxer. This important relative response function illustrates how an entire team's relative performance can be tracked to improve performance in a plurality of ways in a plurality of sports, military performance exercises, and so forth.

FIG. 8 depicts a more generalized method for measuring a biological response to a stimulus. Three panels (steps A, B, C) are shown. The method includes a first step for providing a system of the invention (not shown) and basic steps for operating the system.

First, any codelet mini-script which will support the desired SRS cycle is pushed across the wireless network boundary 34 via external communications path 16 or 19 to a bridge pod 14 from the external communications 18 and from there may be communicated to a plurality of radio node pods 12 forming a mesh network 10.

Second, the sequence is initiated (*, panel B) by a stimulus event or condition such as a specified time, a random time, a particular state of a sensor, a touch, a hit, a throw, a catch, or any signals via the wireless network to all involved radio node pods 12 that the event has started and instructing the pods to initialize the start time to.

Third, any of a plurality of trigger actuation events are executed according to the SRS cycle and biological system responses (hand 24, 24′, both immediate and consequential) are collected by response sensors 22, 22′ and recorded so that the sensor signals can be processed.

Subsequently, any SRS cycle may also include dependent sequential initiations of biological systems relative to each other. For instance, a pitcher biological system 24 may throw the ball after a light trigger device 20 initiates response while later in the stimulus-response sequence 28, a catcher biological system 24′ (panel B) timing starts after he catches the ball for an initiation of response.

Finally in (C), the results are reported to other radio node pods, bridge pods 14, and/or external communications members 18 via links 16 or 19 for any of a plurality of uses including sensory readout (e.g., visual display), further processing, analysis, storage, and/or retransmittal.

Thus, system creates response sensor 22′ input-based sequences via first radio node pod 12 and bridge pod 14 programming that measure the response of a biological system 24 by creating a stimulus 20 and measuring a response as the SRS cycle or cycles are executed. This enables a system adaptable to many types of study including athletic, military, animal, and medical applications.

In an example (not shown) having non-locality of the external communications member(s) 18, the system may be set up by a human on a smart phone over the internet (external communications link 19) from one side of town to the wireless network 10 on the other side of town; having one radio node pod turn on a light (trigger device 20) and send a signal for another radio node pod located on a human to sense heart rate data (sensor device 22) and send each reading back to the smart phone over the Internet (external communications link 16 or 19) to be plotted out as each point becomes available. At any time the radio node pods in this example can be reprogrammed or the function moved to an entirely different radio node pod or bridge pod, allowing a plurality of configurations with the same radio node pod and bridge pod cluster or set.

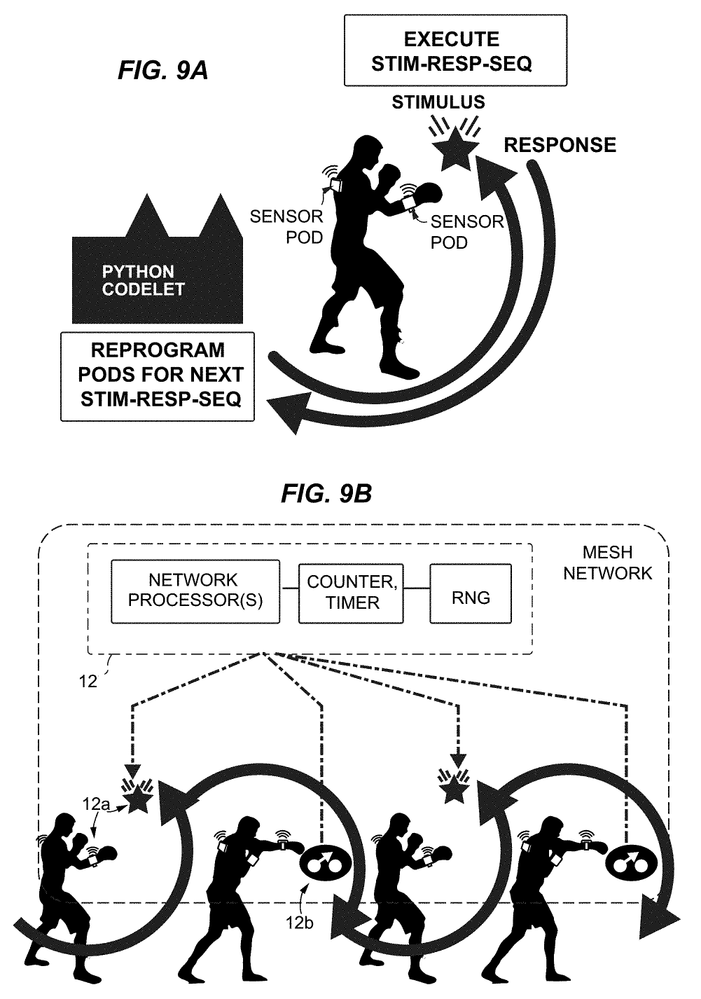

FIG. 9A shows a single stimulus response cycle mediated by a codelet. FIG. 9B shows a chronology of two interactions in which a user is presented with a stimulus, reacts, and the SRS is repeated two times in a row. These iterations are executed by pods of the mesh network working in synchrony. The SRS cycles may be at regular interviews or randomized. Processors are supplied with a counter and timer and may also have a random number generator (RNG) for generating random sequences. Note that the user is wearing three pods, one for monitoring each arm's acceleration and trajectory and the other for measuring body acceleration in preparation for a punch and during recoil. One pod 12a may provide multiple functions, such as a wrist pod that tracks accelerometry and also serves a buzzer to activate a punch. With a pod on both arms, the user may be asked to randomly use one arm or the other according to which buzzer is actuated. While switch sensors 12b are depicted in this figure, the pod with the sensor is mounted on a target such as dummy, an exercise device, or a punching bag. Each of these stimulus and response events is mediated by a cluster of codelets loaded into a mesh network of radio node pods using “just in time” system architecture and a single socket associated with each processor.

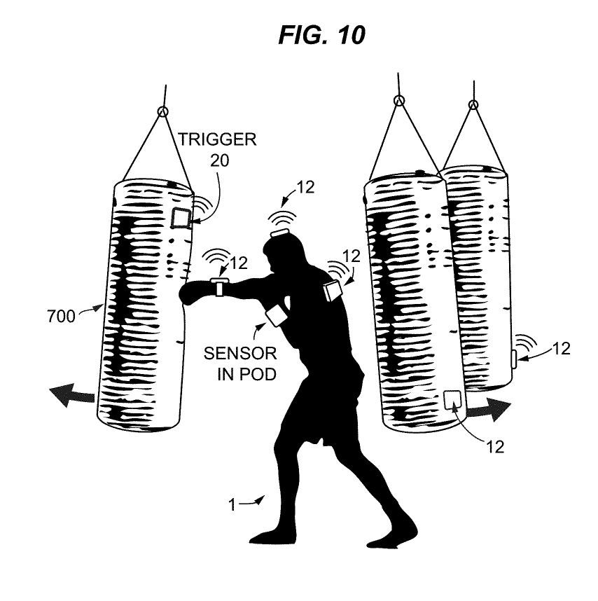

FIG. 10 demonstrates that the apparatus can be re-organized on the fly to present multiple points of interaction with a user while synchronized time and force data is acquired. Here for example, multiple punching bags 700 may be configured with radio node pods 12, each having an independent trigger device. The system may be set up so triggers are actuated in random order among the punching bags, causing the subject 1 to have to be continuously alert to where the next trigger stimulus will come from and to respond by hitting that particular bag. Radio node pods having accelerometry sensors are attached to the bags to detect the impact. Sensors are also placed on the user's wrists and body so that more detailed accelerometry data may be collected. Motion of the bags correlates with the power of the punch. Pods are generally capable of multiple functions and are provided with a cluster of sensors and stimulus devices to support flexible programming.

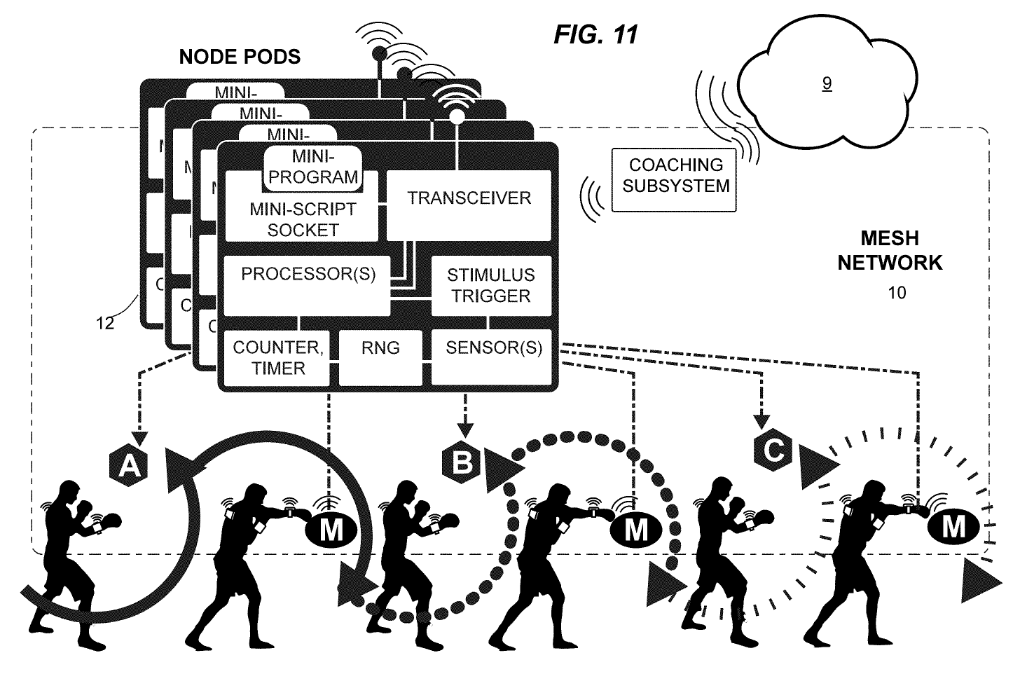

FIG. 11 is a view of a series of interactions A, B, C in which a user is presented with a stimulus and reacts, but in this instance, each SRS cycle is unlike any previous one. These autonomous codelets are not stored in memory, but are loaded over the mesh network into a set of pods just in time to be the next mini-script that is executed under control of a coaching subsystem that in this case is operated from a cloud server 9.

The system includes a sensor package (M) for measuring a response and an actuator, here part of the radio node pods worn on the subject's wrists. In this calculus, four pods 12 are required, three worn by the subject and one to operate the sensor package (M). The computational, sensor and trigger architecture of each pod, however, is identical, providing an economy of deployment. These pods include in addition to a microprocessor, a counter/timer, an RNG, a radio transceiver, a stimulus trigger device or devices, a package of sensors or at least one sensor, and a mini-script socket, here shown with a “mini-program” (“script” or “codelet”) in place. Scripts are small pieces of code (“codelets”) that are readily downloaded into the sockets in a rapid serial radio transmission. Codelets have the advantages that they generally do not require a compiler and are compact for near-instantaneous radio transmission.

The mesh network here is shown to include an intermediary coaching subsystem as part of a bridging function with a cloud host. The coaching system may be configured to provide user feedback and can include display and analysis program that is run from a bridge pod or an accessory smart device, for example.

The radio node pods are in wireless communication with a mesh network 10 and network host 9 and receive updated codelets from the network or host as the workout or exercise program progresses. The particulars of the codelet order are driven by a user preference, an administrative shell, a coaching subroutine, some sensor feedback, safety conditions, or context more generally. The details of codelet parameters may be determined as part of a feedback loop based on user response parameters, such as resistance, frequency, duration, intervals, and so forth, that can be assessed by monitoring heart rate, or a particular program may be tailored to meet a calorie burn goal, for example, or to improve reaction speed, for example.

Codelets enable fast and flexible reconfiguration of wireless data collection radio node pod(s) that can be re-programmed at any time (i.e., “on the fly”) over an external communications link such as to a computer so as to vary the nature and order of the SRS routines presented to a user according to conditions, user goals, performance feedback, or other contextual variables.

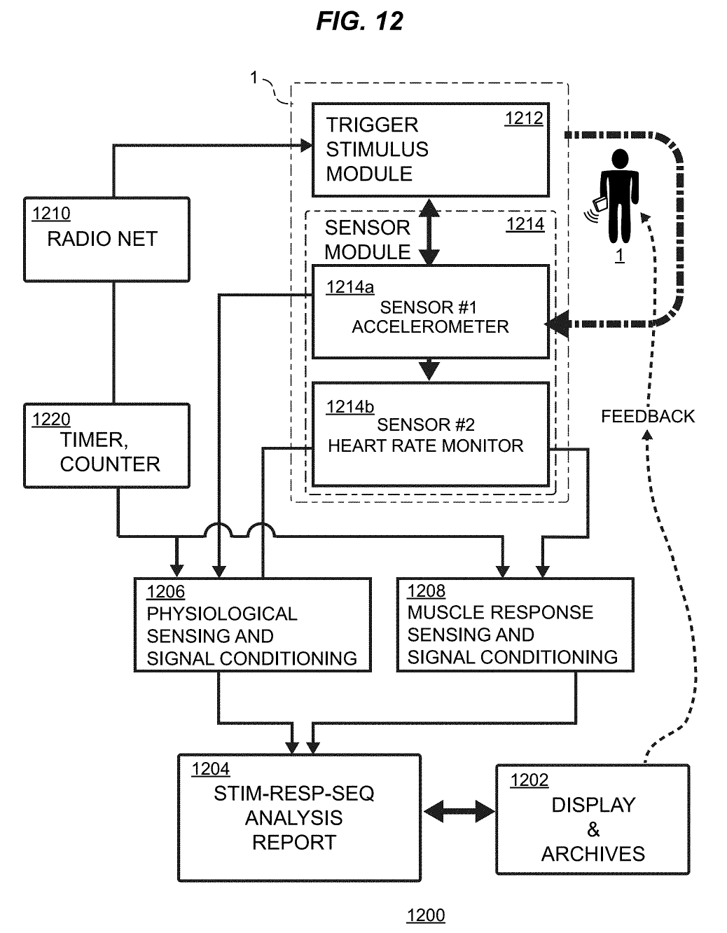

The architecture of these systems 1200 can also be viewed as functional blocks, as shown in FIG. 12. Here feedback is supplied to the user 1 on a display system 1202 that includes capacity to plot historical trends and comparisons with other users and to archive performance results, calibrations and settings. Data may also be analyzed in depth and the display complements reports generated in another functional block 1204. Collection of data includes sensor systems for physiological sensing and data conditioning. Central to operation of the radio node pod mesh network is a trigger-stimulus module 1212 and at least one sensor module 1214 with a sensor or sensors (1214a, 1214b). Shown for illustration is an accelerometer and a heart rate pulse counter (beats/min) that may involve accelerometry or be an auscultatory listening device. Generally a package of sensors are supplied, but alternatively sensors may be provided individually and the radio node pod with one or more plug-in receptacles for receiving and operating the user's choice of sensors.

Also required is a radio net 1210 for exchanging data, resets, timing signals and programming. Timer, clock and/or counter 1220 supports the processor in coordinating sensor, trigger, comm, and program execution functions. With these functional blocks, the system is operational for conducting SRS cycles and for re-configuring the SRS routines at a rapid pace.

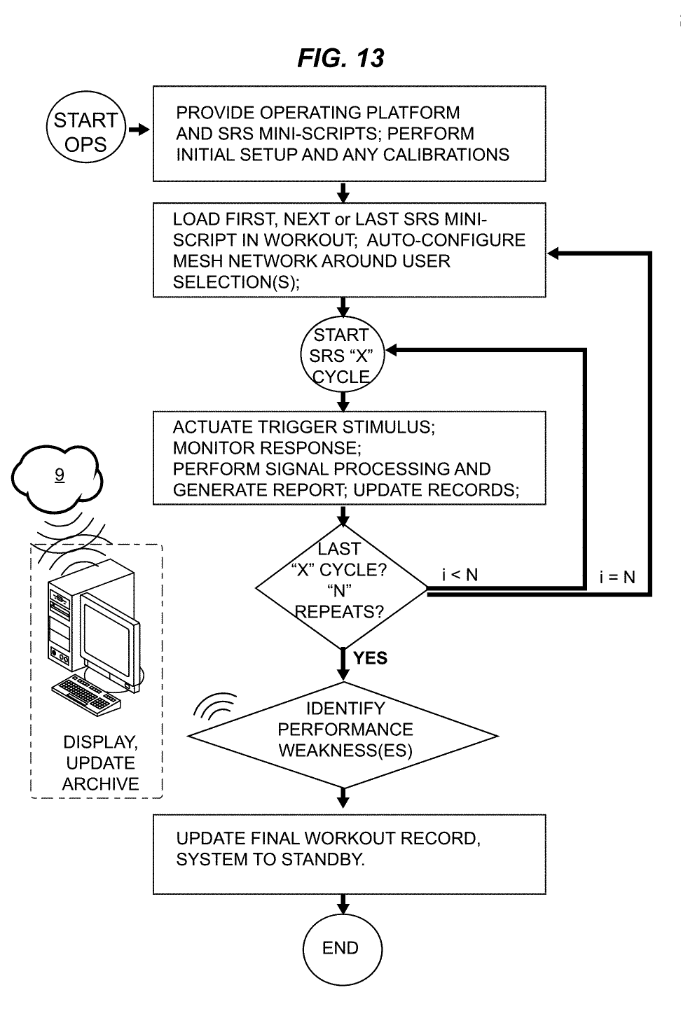

FIG. 13 is a flow chart for operating a workout having multiple repeats and collection of data to identify performance weaknesses. In one embodiment, the workout can be modified in progress to focus training on a particular skill or muscle group. The program has a START and an END and one or more loops in the middle. Here variable “X” indicates a particular SRS cycle type having a unique feature and variable “N” indicates a number of repeats. The flow chart can loop N number of times for each SRS cycle type X. The method begins with a step to provide a system having the functional blocks of FIG. 12 and any needed setup or calibrations. In a first loop, an SRS routine is loaded and any needed radio node pods in the mesh network are configured. The particular nature or order of the SRS routines is dependent on user goals, optionally any coaching function, and any contextual information, such as feedback from past performance, monitoring of heart rate, and so forth that could lead to modification of the workout. In a next loop, a different SRS mini-script may be loaded, and the pace and order of the substitutions is fully controllable on the fly. Once the mesh network and pod clusters are configured, the SRS routine begins by actuation of a trigger stimulus and a monitored sensor response. Signal processing and analysis may be required and may be performed on-board, with spare mesh network resources, on a bridge pod, on in an external host. On completion of each SRS cycle, a decision point is reached that specifies how many repeats (N) of the cycle are programmed and when a new routine is to be loaded. When i=N, a new iteration or training regimen is loaded or the flow chart advances to analysis of the results and the identification of any performance weaknesses. This information is shared with the external host 9. Finally, before the system goes to standby, any records are updated and archived, and will be available next time the subject individual is tested.

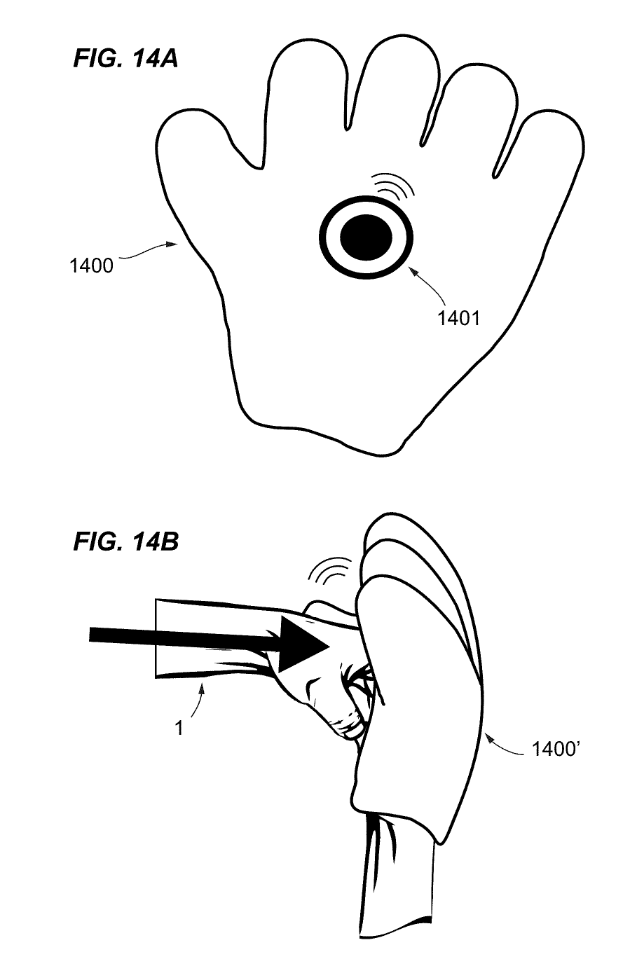

FIG. 14A is a view of a “coaching mitt” (1400) with bullseye center target 1401. A radio node pod is embedded in the palm of the mitt. The bullseye may be used in two ways, first to sense an “on target” hit, and secondly to emit a trigger stimulus. Trigger and sensor devices have been described above. The trigger and sensor devices must be robust enough to withstand a hard hit. The coaching mitt defines a palm side and a back side, and radio node pod is embedded in a target at the center of the glove on the palm side, the glove having a webbing and padding for covering and protecting the radio node pod, the radio node pod having an accelerometric sensor for detecting and measuring an impact of a punch on the target.

Alternatively, the trigger device may be fastened on the backside of the glove, placed in a radio node pod mounted on the subject, or placed where both the subject and the coach observe the trigger event. The sensor in the mitt may be a simple switch that closes when hit, or a more complex sensor for accelerometry and motion detection. Internal sensors and trigger actuators may be supplied with radio connections to a local pod.

FIG. 14B shows the method of use for the device of FIG. 14A. A subject 1, upon sensing a trigger stimulus, begins a punch and attempts to aim for the target. The mitt holder braces for the punch and applies some resistance. The impact stops a timer so that response time (including any delay) can be measured. The method is direct and requires only a radio node pod in the mitt (for both stimulus and response timer).

A radio pod cluster can be implemented to measure velocity and force (as calibrated) if desired. A second radio node pod is used on the subject's wrist or somehow worn or embedded to show the initiation of a response. By timing the initial muscle firing, the response time can be dissected into an initial delay while the trigger is recognized, followed by the actual punch.

Data may be stored on board for later download or may be fed to a bridge pod or local device for analysis and archiving. Over time, the subject will improve speed and have the metrics to prove it.

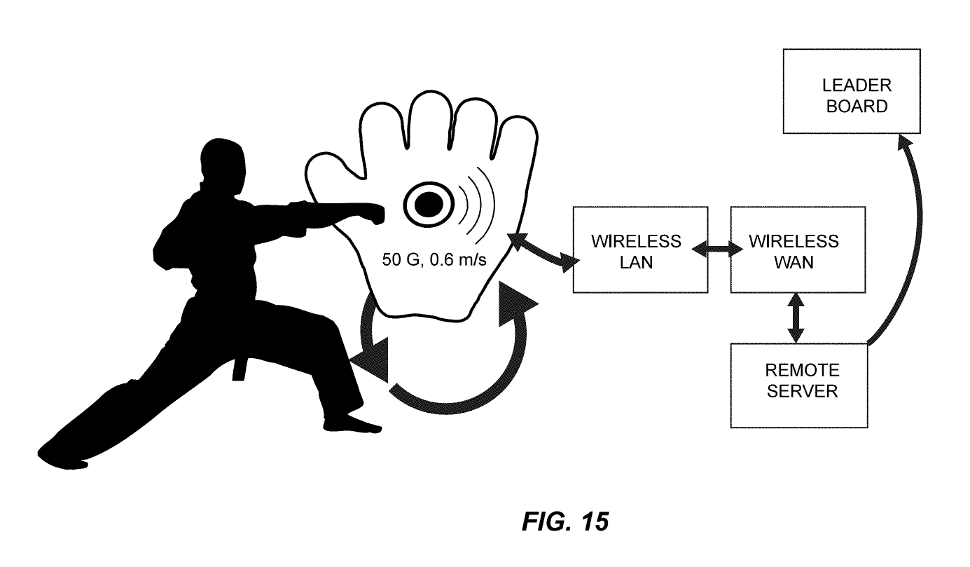

FIG. 15 is a conceptual view of a training session using a mitt with radio node pod in wireless communication with a wireless LAN network and a remote server via a WAN network. Scores for multiple contestants are displayed on a leader board. When using accelerometry, the core programming of the sensor may require selection for an impact load of anywhere from 50 to 100G force and velocities of about 0.5-1.0 meters per second. During the punch, more subtle accelerometry may be needed that requires an accelerometer configured for detecting small motions of a hand or shifts in balance. Thus it may be appropriate to have two accelerometers each tied to a different gain setting. One accelerometer may be used to measure force of impact, and the other to measure trajectory of the punch so that a coach may see whether the punch is being delivered efficiently and on target. By measuring acceleration over the course of the trajectory, parameters of motion related to the speed or velocity of the punch may be captured.

By scoring users simultaneously or consecutively, a relative scoring system is enabled and the scores may be displayed on a leader board as an added incentive to practice. This setup can be used in a variety of martial arts and with slight modification can also be adapted for a full range of moves used in kick boxing. Those skilled in the art will recognize immediately that the mitt can also be used to measure speed of a baseball and with more sensors, coordination of team members in delivering a ball to first base from shortstop or left field. It will also be recognized that with a wrist-worn pod/sensor combination, added metrics can be derived. Use of specialized pods to capture the initial nerve impulse in a muscle movement can divide the full response into an initial delay in which a trigger stimulus is recognized by the subject, a second time delay in which a muscle action potential is developed, and a third phase in which arm motion is coordinated into delivery.

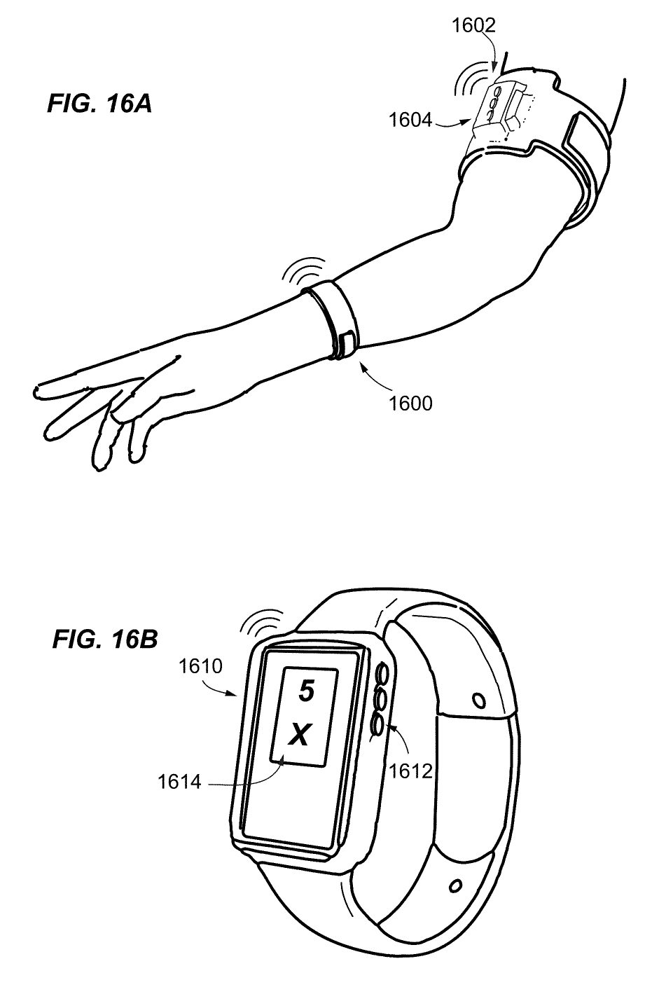

FIGS. 16A and 16B are accessories used in systems of the invention. Each is a wearable wireless device equivalent to a radio node pod and having a microprocessor, radio or beacon, mini-script socket, clock and supporting circuitry. Both are secured to an arm, one to better assess acceleration and trajectory, the other to detect tensing characteristic of an early muscle response. Other accessories may be a shoe- or heel-mounted radio node pod in radio communication with a mesh network. Also conceived is a mouth guard or mouthpiece having radio node pod capability in a housing resistant to bite and saliva.

FIG. 16A shows a more complex wearable pod (or pods) having a wrist-worn component 1600 for measuring distal arm velocity and trajectory and a cuff 1602 worn on the bicep of a subject for measuring initial muscle response. The wrist device may also measure radial artery pulse rate and pressure. The cuff may also record blood pressure and radio an alarm if the blood pressure is over a threshold and may include user controls for customizing the SRS cycle or advancing to a new routine, for example. The wearable devices may be fastened to the user's arm with a strap, an elastic band, VELCRO® or an adhesive. Either of the devices may include a user interface 1604, 1614.

FIG. 16B is a rendering of a wrist-worn device 1610 with multiple user-selectable functions and a display 1614. System status, data, comparables, time, and inputs to the SRS program may be displayed and ramped up and down with buttons 1612 or other user control surfaces. The device is preferably water and impact resistant and may house a complete radio node pod, thus serving as a specialized pod for receiving and executing codelets but also having a core computer function of displaying measured parameters or even selecting from a menu of practice routines.

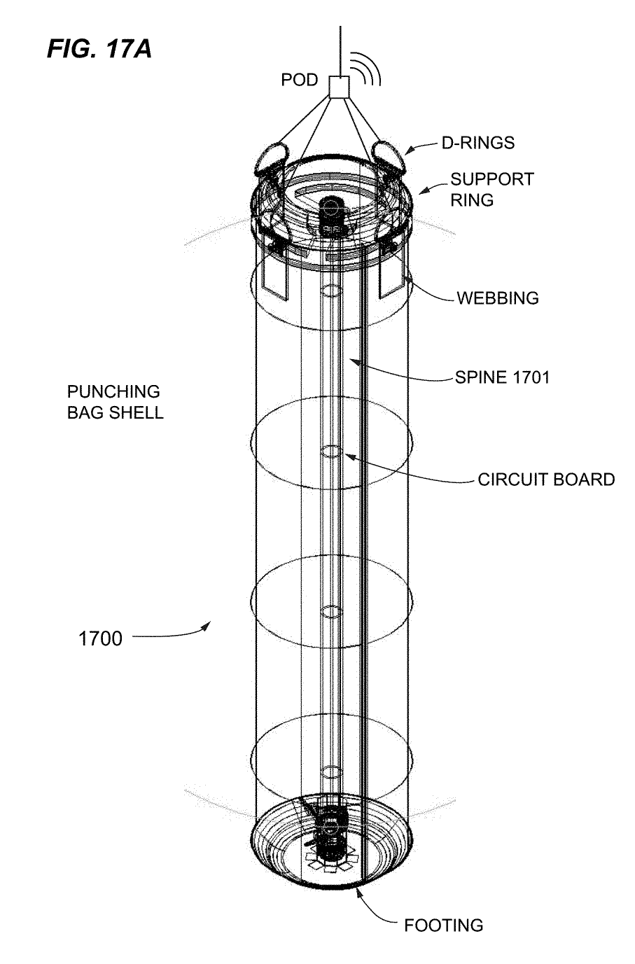

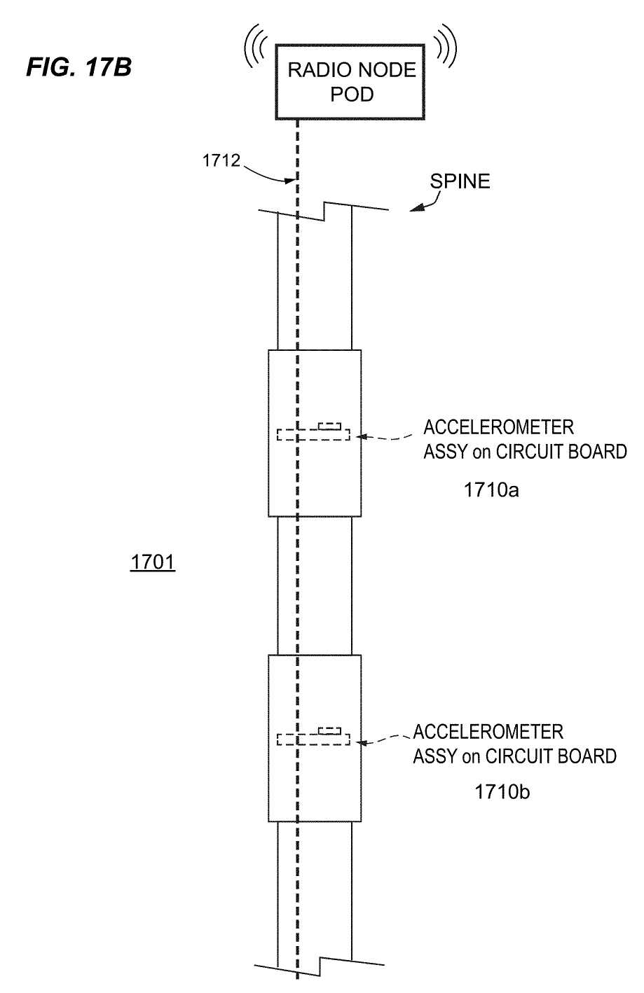

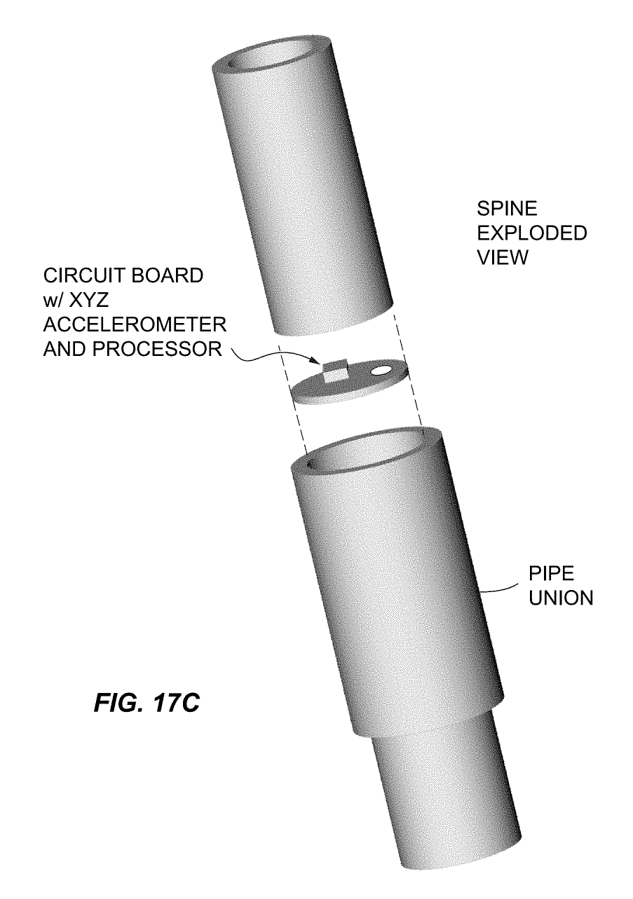

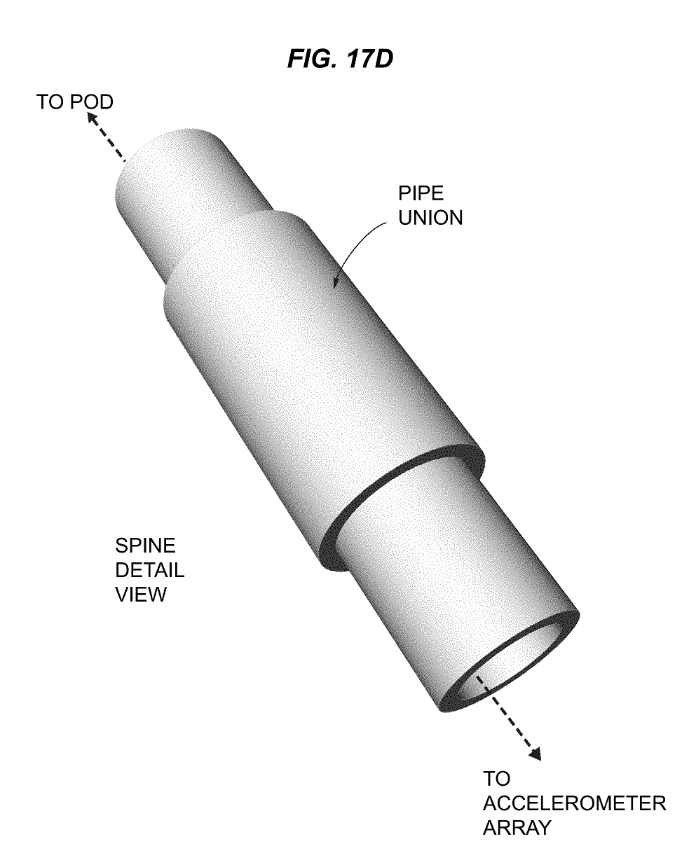

FIGS. 17A through 17D are views of a punching bag 1700 with internal “spine” 1701 subassembly for spacing radio node pods so that the entire subassembly can more easily be removed for repair or replacement. Shown here is a punching bag with internal spine for spacing a stack of sensors in which each sensor is mounted on a circuit board. The tubular spine is disposed centrally on the long axis of the punching bag. Each sensor node is spaced to permit measurements along the long axis of the punching bag. Each node comprises a circuit board with processor and at least one sensor, most preferably an XYZ accelerometer. These nodes may feed data, typically via a wired link, to a radio node pod with multiplexer for reading multiple sensor inputs associated with an impact to the punching bag. The radio node pod may be located at a common apical link in the physical harness by which the punching bag is suspended so as to better estimate the total force imparted to the bag in an impact, such as with a calibrated resistance, eddy current, or capacitance force sensor. Radio node pods may also be distributed in the webbing or the D-rings supporting the external shell of the bag. The padding in the bag is sufficient such that the circuit boards are not damaged by repeated impacts.

In this view, the response device comprises an improved punching bag with apex and base, wherein the punching bag is modified with an insertably removable spine assembly with rigid tubular support, a plurality of accelerometric sensor assemblies disposed along the spine, a radio node pod at the apex of the punching bag, and a wire harness for power and data that extends down the spine from the radio node pod to the accelerometric sensor assemblies.

FIGS. 17C and 17D are CAD views of the spine assembly 1701 in exploded view and in part, showing a tubular spine and sleeve designed to receive a circular circuit board with accelerometer assembly at intervals. The circuit includes a hole for running a wiring harness the length of the accelerometer array. The wiring harness supplies power to the sensor assemblies and returns data to a radio node pod mounted at the top of the spine or in the support harness. FIG. 17C is a CAD view of a first embodiment of a sensor array. Distributing the sensors 1710a,1710b at a series of levels or “sections” allows the operator to calibrate the overall force against the bag by a weighted average of mass for each section of the bag, and applying the equation F=ma or a transfer function.

Alternatively, the sensor units 1710a,1710b can be wired to a single radio node pod mounted at the apex of the assembly where a connection is made to an overhead support. Multiple circuit boards are disposed over the length of the spine. Signals are transmitted to a radio node pod mounted at the top of the punching bag suspension. Thus the spine may also serve as a wiring conduit if desired with accelerometers mounted at discrete distances from the apex.

Communication with the accelerometer array (1710a,1710b) can be managed with a UART or other serial bus technology extending from the microprocessor in the radio node pod. FIG. 17B is a schematic illustrating spaced sensor assemblies wired with wire harness 1712 to a radio node pod. In this way, the satellite circuit board members in the spine can share power and data with the radio node pod.

In one of the preferred embodiments, an accelerometric sensor in a radio node pod is deployed on a spring washer at the suspension ring at the apex of the punching bag rig, in which the bag is supported at the top by a stiff leaf spring (i.e., the spring washer) that is instrumented for measuring deformation. Alternatively, the radio node pod(s) may include load cells mounted in the buckle at the top of the chain suspension or in the D-rings.

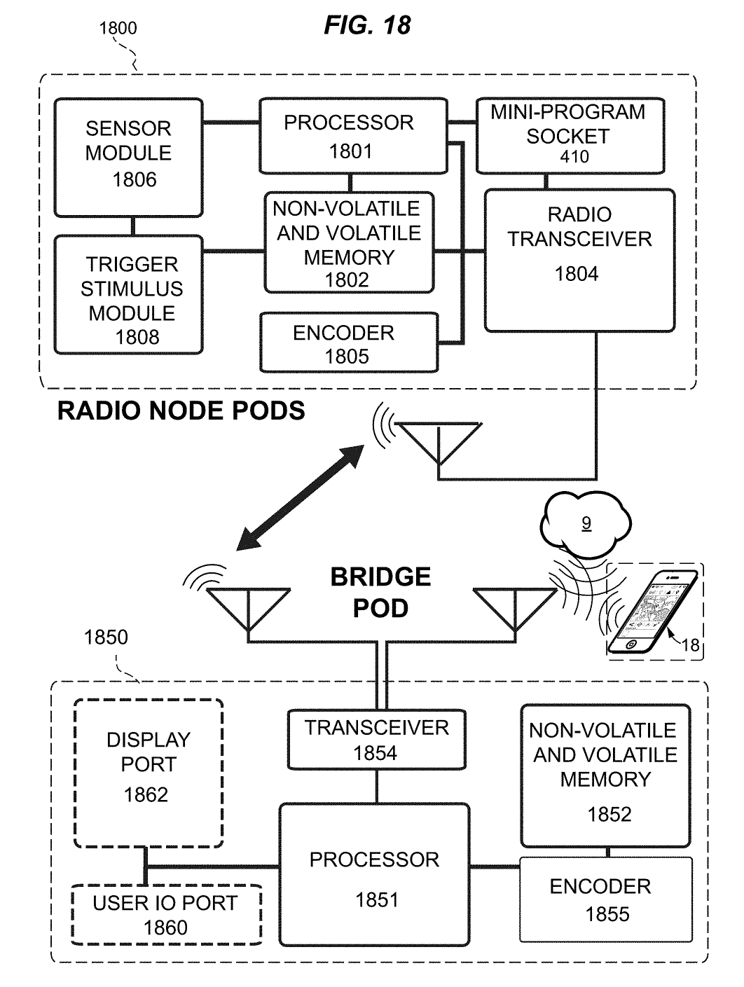

FIG. 18 is a schematic of the interactions between an exemplary radio node pod 1800 and a bridge pod 1850, as are combined in a preferred mesh network having a cluster or clusters of radio node pods with a common bridge pod. In this embodiment, the radio node pod is equipped with an antenna for local transmission on a LAN and the bridge pod has a second antenna selected for WAN communication to an external comm gateway or portal such as smart device or a cell tower. Both devices include a microprocessor (1801,1851) and associated memory 1802,1852. On board radio transceivers 1804,1854 having minimal dimensions are selected. Preferably the radio node pod operates on battery power. The transceiver may be operatively linked to an encoder unit 1805 for formatting bluetooth radio messages in frames or byte strings as needed for transmitting and receiving data and codelets. The radio transceiver 1854 on the bridge pod may be a broadband radio transmitter for communications with an external comm portal or gateway 18 and cloud host 9, but may also include an encoder 1855 and bluetooth-compatible signal generator for operating a radioset compatible with the radio node pod receiver. Alternatively the processor may handle the communications protocols and the formatting of radio messages. The radio node pod also will include a sensor module 1806 and a trigger stimulus module 1808 with stimulus device needed for initiating and executing SRS routines. The bridge pod may include an I/O port 1860 for interfacing with a user's smart device and a display port 1862 for connecting to a monitor, although these are optional, as are sensor and stimulus modules on the bridge pod. Thus while some specialization is conceived, radio node pod and bridge pod architecture have many shared features and in a preferred embodiment, may be designated to be omnifunctional without need to manufacture distinct devices. In a hybrid of the two, plug connections on the bridge pod may be add-ons that are soldered onto existing board leads, for example, so that the devices are manufactured from a common base and modified only in a final step of manufacturing and assembly.

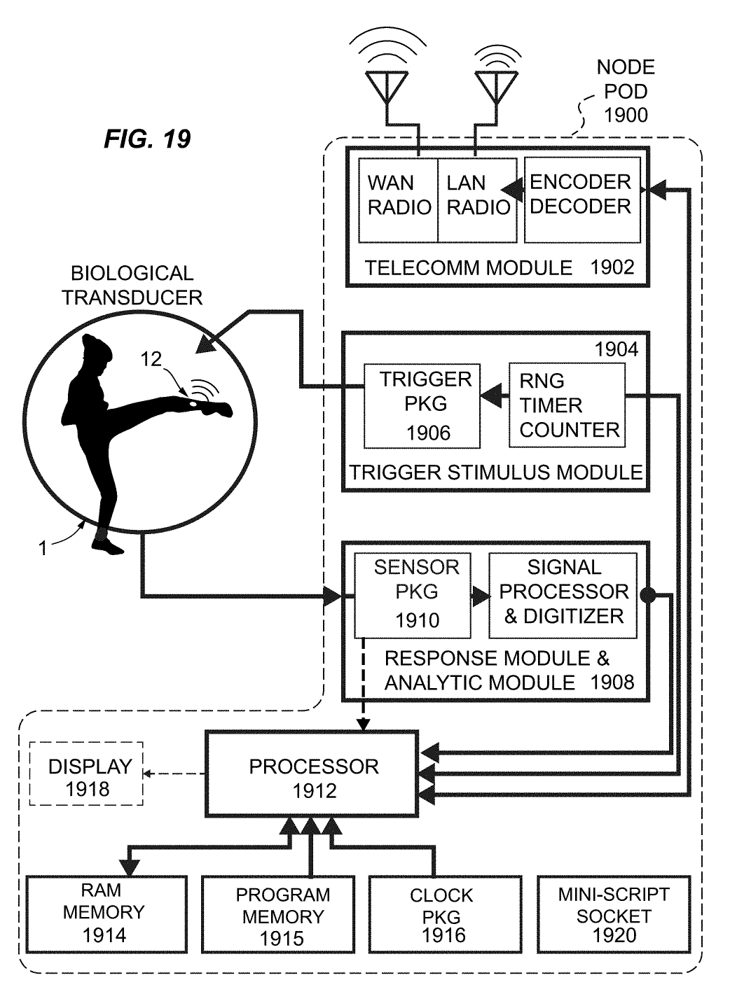

FIG. 19 illustrates a specialized radio node pod 1900 with two radios, one for LAN the other for WAN radio comms so as to avoid the need for bridge pods. The LAN radio may be a bluetooth radioset. The radio sets are organized into a telecomm module 1902. Also organized as modules are a) a trigger module 1904 with trigger package 1906 and counter timer and b) a response module 1908 with analysis logic and incorporating a sensor package 1910 and a signal conditioning unit. These units support a microprocessor 1912 configured with RAM (1914), ROM (1915, for holding non-volatile program code), a clock and timer/counter package (1916) with optional random number generator, an optional display (1918) or user interface, and a mini-script socket (1920) for receiving program codelets as described earlier. Thus the radio node pod architecture is envisaged to be a family of device architectures having general functional equivalency but varying in cost, simplicity and details of firmware. RISC instruction sets may be written to support a variety of firmware configurations. The subject individual is termed a “biological transducer”, indicating an essential role in the SRS cycle by transducing stimuli into behavioral responses and motion, the physics of which are qualitative or quantitatively measurable. Shown here is an ankle radio node pod used for practicing kicks.

### Example I

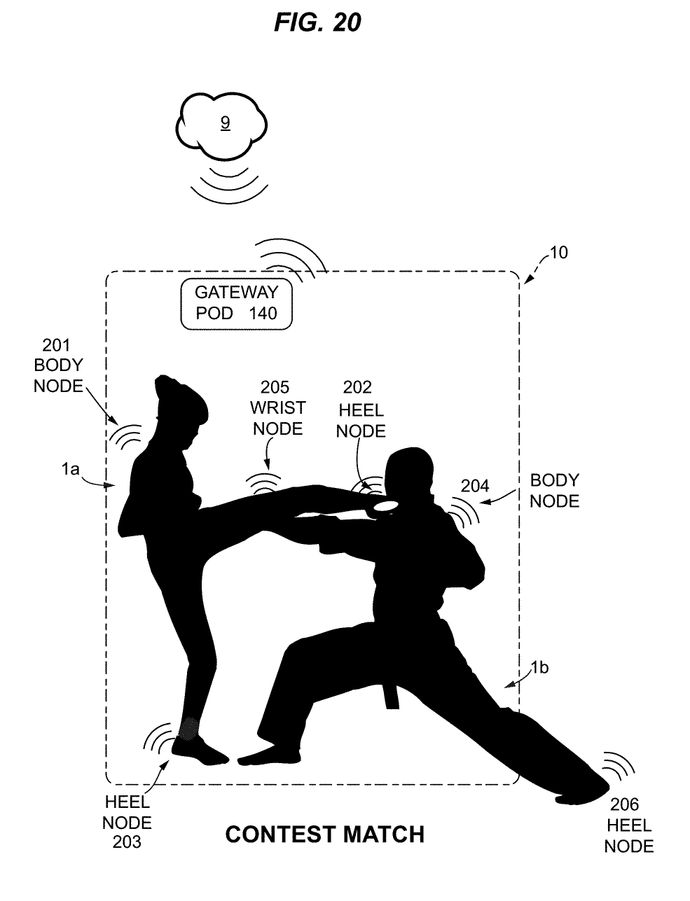

FIG. 20 is a spatial view of a mesh network with two contestants, and points out that the SRS routines may be extended to multiple subjects. In this example of a complete system and its use in multi-subject play, each user may be wearing multiple miniature radio node pods and will interact with the sensor packages of several other radio node pods. Each blow becomes a stimulus for a next blow, and each response becomes a stimulus for a next response.

Communications between a radio node pod and a bridge pod (generalized here as a “gateway pod 140”) extend to a cloud server 9. The gateway pod serves as a portal to a cloud host with remote server operated to display contest results on a leader board as may be used for competition, tourneys, and for team training. Team training may involve systems and methods for collecting reaction data of multiple individuals in response to one or more stimuli. Wireless networking and systems for sensing, quantitating, and processing reaction data triggered by programmable synchronous or random patterns also contemplate systems in which one user's response triggers actions of others that are not fully predictable but are relatively easily measured by the system because of the multipotency of the radio node pods and their fast and easy reprogramming using codelets. Complex system modelling is not needed because all the results of unpredictable sequential interactions with a second or a plurality of subjects are handled at a megahertz or gigahertz frequency in a wireless network and the data is chronologically precise so as to permit isolation of individual user performance and its impact on the performance of others.

In the context of a contest match, not a training session, shown here are two sparring partners 1a, 1b. Each of the sparring partners is provided with three radio node pods having an architecture essentially as described in FIG. 19. The gateway pod serves to buffer data and commands exchanged between the mesh network formed by ten radio node pods and a cloud server that has detailed profiles on the two individual subjects and their past matches. The cloud server in this illustration will also be scoring the match. Points are given for various blows and combinations, and the match could be a karate match or a kickboxing match, for example.

The radio pods are wirelessly connected into a mesh network. In this instant in the match, as drawn in FIG. 20, contestant 1a has landed a blow against the head of contestant 1b, largely deflecting the force of contestant 1b's punch. The machine has captured the force behind the kick using the heel node 202 and heel node 203 and can determine how much force is received by the opponent by measuring force at body node 204. Similarly, the punch by contestant 1b is measured at wrist node 205 and body node 201. The machine will score a point for contestant 201 because the kick preceded the punch by a few milliseconds and was a stronger blow, even though it was partially deflected by the punch. Both contestants must now recover their positions and prepare for a next iteration. Because contestant 1a is extended and must return both feet to a fighting stance, that action will necessarily be slower than the action of contestant 1b who can move the foot with heel node 206 forward, plant it solidly to close with his opponent, and deliver a counterpunch to the body that will be detected and measured by radio node pod 201. This blow is likely to be sufficient to knock contestant 1a back and off balance, and contestant 1b can follow up with a series of blows that force the opponent out of the ring or cause a fall. Only if contestant 1a recovers rapidly to convert her momentum into a tumble, can she stay in the match. The mesh network will have dissected the match into a series of iterations in which a blow is initiated with a shift in weight at one or both feet and is terminated by an impact on an opponent. The speed of the opponents recovery from the blow can be compared with the speed at which the contestant who delivered the blow can recover to strike again or to fend off a counterstrike. By analyzing the trajectories of motion of each limb, the system can determine which contestant has more control and efficiency of motion and is more effective in delivering the force of the blow to the opponent. The system can also look for success in positioning “chi” through the feet without misstep and for moving the body in a way that defines a recognized “kata”, a pose and stroke that the contestants will have practiced and will use in the match to score points. If one subject does stumble, the system will measure how the opponent takes advantage of the temporary imbalance. Thus the system will have a detailed analysis of the match, all the points that are scored, and any fine points of technique that add or subtract from the overall mastery of the sport for each contestant.

The same hardware and system components that are used in training are also useful in scoring performance in a contest at a tournament. The system will archive the results and can be used to augment a video replay so that the players can see how their body motions scored as for balance and efficiency in making blows count. The wrist sensors can also monitor blood pressure and oxygenation and can call the match if it becomes dangerous to continue.

### Example II

In a second example, a system is built around an accelerometer sensor package having a dynamic range in the tens or hundreds of G's. A trigger stimulus device, initially a colored LED, was mounted in a glove and was presented to a subject. As was observed, the subject punches at a target and the mitt-holder braces against the punch. The target device embedded in the glove has an array of sensors to more precisely quantitate precision of the hit and the impact intensity. This system has been demonstrated to sports clubs, dojos and home users and is found to function reliably in a mesh network configuration. Python was used to code the mini-scripts provided over a wireless network on the fly to the processors of the mesh network.

A calibration system was used to achieve accurate relative results without the need for complex transfer functions.

### INCORPORATION BY REFERENCE

All of the U.S. patents, U.S. patent application publications, US patent applications, foreign patents, foreign patent applications and non-patent publications referred to in this specification and related filings, whether commonly owned or not, are incorporated herein by reference in their entirety for all purposes.

### SCOPE OF THE CLAIMS

The disclosure set forth herein of certain exemplary embodiments, including all text, drawings, annotations, and graphs, is sufficient to enable one of ordinary skill in the art to practice the invention. Various alternatives, modifications and equivalents are possible, as will readily occur to those skilled in the art in practice of the invention. The inventions, examples, and embodiments described herein are not limited to particularly exemplified materials, methods, and/or structures and various changes may be made in the size, shape, type, number and arrangement of parts described herein. All embodiments, alternatives, modifications and equivalents may be combined to provide further embodiments of the present invention without departing from the true spirit and scope of the invention.

In general, in the following claims, the terms used in the written description should not be construed to limit the claims to specific embodiments described herein for illustration, but should be construed to include all possible embodiments, both specific and generic, along with the full scope of equivalents to which such claims are entitled. Accordingly, the claims are not limited in haec verba by the disclosure.

We claim:

1. A system for training an individual subject or a team of subjects in a plurality of exercises, which comprises:
a) a wireless mesh network having a plurality of radio node pods;
b) the radio node pods having each a processor operative with two or more memory units, a radio address and a radio node pod identifier, a transceiver for sending and receiving radio signals to and from the mesh network, a portable power supply, a clock, a stimulus device for generating a visual, tactile or acoustic stimulus that defines a stimulus event, at least one response device with sensor or sensors for detecting, measuring and clocking a response to a stimulus, thereby defining a response measurement, wherein said sensor or sensors comprise a multi-axis accelerometer and each response measurement comprises one or more measurements of one or more vectored parameters of motion of a subject;
c) wherein the processor and the memory units are configured for receiving, storing and executing program instructions, the program instructions comprising:
i) nonvolatile instructions for executing core functions of a radio node pod, the core functions comprising instructions for generating a stimulus by the stimulus device, for detecting and for measuring a response by the response device, for digitizing stimulus and response data, and for sending and receiving data to and from the mesh network;
ii) volatile instructions addressable to one or any combination of radio node pods of the mesh network, wherein the volatile instructions are wirelessly receivable as a first and a next codelet of a series of addressable codelets, the series defining an iteration of a training regimen, each codelet having associated variables, wherein each codelet is executable in order received, and the codelet and associated variables are configured for structuring the stimulus device and the response device of an addressed radio node pod to perform a function in the iteration; and,
d) wherein the series of addressable codelets are configured to define a first iteration, a next iteration and a prior iteration, the wireless network is configured to perform an analysis of each of the response measurements transmitted to the network, and the associated variables, addresses, and order of the codelets in the series of codelets of the next iteration are reprogrammable by the wireless mesh network according to the analysis of the response measurements in a prior iteration until no further stimulus event or next response is detected.

2. The system of claim 1, wherein stimulus device is configured to initiate a first iteration by generating a visual, tactile or acoustic stimulus.

3. The system of claim 2, wherein the response in a first iteration is a stimulus in a next iteration.

4. The system of claim 1, by the mesh network, comprising programmable instructions for reprogramming a series of codelets transmitted to radio node pod so as to adapt a training regimen from a first exercise routine or sport to a second exercise routine or sport.

5. The system of claim 1, by the mesh network, comprising addressable codelets in any series of codelets transmitted to a plurality of radio node pods such that any individual radio node pod of a plurality may receive a unique codelet or series of codelets, thereby enabling any like radio node pod to exhibit unique behavior according to a response measurement outcome of a prior iteration.

6. The system of claim 1, further comprising a radio bridge pod having a transceiver for collecting response data from the radio node pods of the mesh network, for transmitting the data to a server on a wide area network, for receiving a series of codelets with specified variables from the server, the codelets defining an iteration, and for reprogramming the radio node pods by transmitting the series of codelets with specified variables to the radio node pods of the mesh network.

7. The system of claim 6, wherein the server is configured for receiving and analyzing parameters of motion from the local network for one or more responses of an individual, calculating one or more individual performance analytics, storing team performance analytics, and displaying team performance analytics on one or more display devices.

8. The system of claim 7, wherein the server is configured for reprogramming the associated variables, addresses, and order of the codelets in a series of codelets of the next iteration that are transmitted to the radio node pods of the local network according to individual profiles, team profiles, team member profiles, historical trends, aggregated or comparative metrics, or behavioral signatures in the analytics.

9. The system of claim 8, wherein the server is configured for reprogramming the sequence of or kinds of codelets and specified variables according to heuristic programming or predictive logic resident in the server.

10. The system of claim 1, wherein the mesh network is configured for synchronizing the clocks of the radio node pods to an absolute reference time, a time offset that synchronizes the processors of the radio node pods, or a time zero before each training regimen.

11. The system of claim 1, further comprising a radio bridge pod, said radio bridge pod comprising a data processing circuit enabled to process response measurement data received from the mesh network of radio node pods, a wide area transceiver, and a personal computer or smart device for displaying and storing raw or processed data.

12. The system of claim 1, wherein the mesh network is configured with an external communications path for exchanging data with a personal computer, a laptop, a personal data assistant, a smart phone, or other Internet-compatible device enabled to calculate, track and report performance metrics for an individual or team.

13. The system of claim 12, wherein the personal computer, a laptop, a personal data assistant, a smart phone, or other Internet-compatible device is enabled to report a trend or trends in performance.

14. The system of claim 13, wherein the series of addressable codelets and associated variables transmitted to the mesh network are configured be reprogrammed according to a trend or trends in performance.

15. The system of claim 1, wherein the vectored parameters of motion include a double integral calculation of a motion and position of a limb of an individual with respect to time and the response device comprises a switch configured for detecting an impact.

16. The system of claim 15, wherein the switch for detecting an impact is configured to output a response measurement and a clock time of the impact and the impact is a stimulus event for beginning a next iteration.

17. The system of claim 1, wherein the mesh network is configured to operate with a number of radio node pods sufficient to outfit a team.

18. The system of claim 1, wherein the mesh network is configured to operate with a number of radio node pods sufficient to outfit two teams.

19. The system of claim 1, wherein the radio node pods comprise a bluetooth radio set configured to broadcast a radio signal comprising a device identifier, a radio address of a receiving unit or units, any response data, and to receive a radio signal comprising a codelet or a series of codelets and associated variables.

20. The system of claim 1, wherein the radio node pods are embedded so as to be worn by a player or in a device embedded in a piece of sports or exercise equipment.

21. The system of claim 20, wherein the response device comprises an improved punching bag with apex and base, wherein the punching bag is modified with an insertably removable spine assembly with rigid tubular support, a plurality of accelerometric sensor assemblies disposed along the spine, a radio node pod at the apex of the punching bag, and a wire harness for power and data that extends down the spine from the radio node pod to the accelerometric sensor assemblies.

22. The system of claim 20, comprising a coaching mitt with palm side and back side, wherein a radio node pod is embedded in a target at the center of the mitt on the palm side, the mitt having webbing and padding for covering and protecting the radio node pod, the radio node pod having an accelerometric sensor for detecting and measuring an impact of a punch on the target.
